(19) United States
(12) Patent Application Publication
(10) Pub. No.: US 2017/0251357 A1
(43) Pub. Date: Aug. 31, 2017

(54) METHOD AND DEVICE FOR TRANSFERRING MOBILITY MANAGEMENT AND BEARER MANAGEMENT

(71) Applicant: NEC Corporation, Tokyo (JP)

(72) Inventors: Takanori IWAI, Tokyo (JP); Hajime ZEMBUTSU, Tokyo (JP); Toshiyuki TAMURA, Tokyo (JP); Hisashi FUTAKI, Tokyo (JP)

(73) Assignee: NEC Corporation, Tokyo (JP)

(21) Appl. No.: 15/505,951

(22) PCT Filed: Jun. 15, 2015
(86) PCT No.: PCT/JP2015/002989

§ 371 Date: Feb. 23, 2017

(30) Foreign Application Priority Data
Sep. 5, 2014 (JP) 2014-181169

(51) Int. Cl. H04W 8/08; H04W 40/02

(52) U.S. Cl. CPC H04W 8/08; H04W 40/02; H04W 92/14

(57) ABSTRACT

When mobility management and bearer management of a mobile terminal (111) that is in an idle state and that is associated with a particular core network node identifier (GUMMEI or V-GUMMEI) are transferred from a first core network node (121S) to a second core network node (121T), a base station (112) configures itself to change, from the first core network node (121S) to the second core network node (121T), a forwarding destination of a Non-Access Stratum (NAS) message that is transmitted by the mobile terminal (111) and that is addressed to the particular core network node identifier (GUMMEI or V-GUMMEI). This contributes to, for example, preventing occurrences of signaling involving a mobile terminal when mobility management and bearer management of the mobile terminal in an idle state are transferred between core network nodes.

### TECHNICAL FIELD

The present disclosure relates to a mobile communication network, and more particularly to mobility management and bearer management of mobile terminals in a core network.

### BACKGROUND ART

Non-Patent Literature 1 specifies the functional architecture of a packet switching domain of the Third Generation Partnership Project (3GPP), which is an Evolved Packet System (EPS). To be specific, Non-Patent Literature 1 specifies various procedures for mobility management, session management and handover of mobile terminals in the EPS, including Attach procedure, Tracking Area Update (TAU) procedure, Service Request procedure, S1 Release procedure, Globally Unique Temporary Identity (GUTI) Reallocation procedure, Detach procedure, Dedicated bearer activation procedure, Bearer modification procedure, X2-based handover procedure and S1-based handover procedure.

### CITATION LIST

### Non Patent Literature

NPL1: 3GPP TS 23.401 V9.15.0 (2013-03) “3rd Generation Partnership Project; Technical Specification Group Services and System Aspects; General Packet Radio Service (GPRS) enhancements for Evolved Universal Terrestrial Radio Access Network (E-UTRAN) access (Release 9)”, March 2013

### SUMMARY OF INVENTION

### Technical Problem

The inventors have studied transfer of processing of a Mobility Management Entity (MME) (i.e., mobility management and bearer management) to another MME, which is autonomously performed by a core network regardless of the movement of a UE (User Equipment). In this specification, the taking over of the mobility management and bearer management in the manner described above is referred to as transfer or relocation of mobility management and bearer management. Note that, MMEs are located in a core network, which is an Evolved Packet Core (EPC), and performs mobility management and bearer management of mobile terminals (User Equipments (UEs)) that have attached to the core network (i.e., in EMM-REGISTERED state). The mobility management is used to keep track of the current location of a UE and includes maintaining a mobility management context (MM context) related to the UE. The bearer management includes controlling an establishment of an EPS bearer for a UE to communicate with an external network (Packet Data Network (PDN)) via an Evolved Universal Terrestrial Radio Access Network (E-UTRAN) and an EPC and also includes maintaining a bearer management context (i.e., EPS bearer context) related to the UE.

The autonomous transfer (relocation) of mobility management and bearer management in a core network may be started in accordance with a command from an external control node (e.g., Software-Defined Network (SDN) controller, Network Function Virtualization (NFV) controller, Operations Support System (OSS), or Element Management System (EMS)), or the transfer may be started on the initiative of an MME. The inventors expect that the demand for the transfer of mobility management and bearer management will grow with the increasing use of core network virtualization technology. A virtualized core network (which is called, for example, Virtualized EPC) abstracts one or both of the control plane and the data plane of a core network through the use of server virtualization technology and network virtualization technology. Specifically, in a virtualized core network, core network nodes (e.g., MME, Serving Gateway (S-GW)/PDN Gateway (P-GW) control plane, and S/P-GW data plane) are implemented as virtual machines configured in a server pool or as virtual routers configured in physical switches.

The current 3GPP specifications define a procedure to transfer mobility management and bearer management of an UE from an old MME (or source MME) to a new MME (or target MME) when the UE moves across a boundary between tracking areas or between eNodeBs. To be specific, when a UE in an idle state (i.e., although the UE is in EMM-REGISTERED state, it is also in Radio Resource Control (RRC)_IDLE and EPS Connection Management (ECM)-IDLE states)) moves from a tracking area under control of an old MME to a tracking area under control of a new MME, the mobility management and bearer management of this UE are transferred from the old MME to the new MME in the TAU procedure. Further, when a UE in a connected state (i.e., in EMM-REGISTERED, RRC_CONNECTED, and ECM-CONNECTED states) moves from a source eNodeB (eNodeB) controlled by a source MME to a target eNodeB controlled by a target MME, the mobility management and bearer management of this UE are transferred from the source MME to the target MME in the S1-based Handover procedure.

However, the current 3GPP specifications define nothing about the transfer of the mobility management and bearer management of a UE between MMEs regardless of the movement of the UE, on the initiative of the EPC or a control node (e.g., SDN controller, NFV controller, OSS or EMS) coupled to the EPC. Moreover, when the mobility management and bearer management of an UE in the idle state are transferred between MMEs, it may be preferable to complete the transfer procedure without notifying the UE in the idle state of the occurrence of the transfer (relocation). This is because notifying the UE in the idle state of the occurrence of transfer (relocation) (i.e., MME change) requires much signaling, including paging, an RRC connection establishment, and an S1 signaling connection establishment, to transmit a downlink Non-Access Stratum (NAS) message, thereby leading to an increase in the load of the network.

Thus, an object to be attained by illustrative embodiments disclosed herein is to provide a device, a method, and a program that contribute to preventing occurrences of signaling involving a mobile terminal when mobility management and bearer management of at least one mobile terminal (e.g., UE) in the idle state (e.g., in RRC_IDLE state and in ECM-IDLE state) are transferred between core network nodes (e.g., MMEs). Note that this object is only one of the objects to be attained by the illustrative embodiments disclosed herein. The other objects or problems and novel features will be made apparent from the following description and the accompanying drawings.

### Solution to Problem

In a first example aspect, a method for transferring mobility management and bearer management includes:

(a) transferring mobility management and bearer management of at least one mobile terminal, in an idle state and associated with a particular core network node identifier, from a first core network node to a second core network node; and
(b) configuring a base station to change a forwarding destination of a Non-Access Stratum (NAS) message from the first core network node to the second core network node upon the transfer of the mobility management and the bearer management of the at least one mobile terminal, the NAS message being transmitted by each of the at least one mobile terminal and being addressed to the particular core network node identifier.

In a second example aspect, a method performed by a base station includes, when mobility management and bearer management of at least one mobile terminal, in an idle state and associated with a particular core network node identifier, are transferred from a first core network node to a second core network node, configuring the base station to change a forwarding destination of a Non-Access Stratum (NAS) message from the first core network node to the second core network node, the NAS message being transmitted by each of the at least one mobile terminal and being addressed to the particular core network node identifier.

In a third example aspect, a method performed by a first core network node located in a core network includes:

(a) transferring mobility management and bearer management of at least one mobile terminal, in an idle state and associated with a particular core network node identifier, from the first core network node to a second core network node, and
(b) instructing a base station to change a forwarding destination of a Non-Access Stratum (NAS) message from the first core network node to the second core network node upon the transfer of the mobility management and the bearer management of the at least one mobile terminal, the NAS message being transmitted by each of the at least one mobile terminal and being addressed to the particular core network node identifier.

In a fourth example aspect, a method performed by a second core network node located in a core network includes

(a) taking over, by the second core network node, mobility management and bearer management of at least one mobile terminal from a first core network node, the at least one mobile terminal being in an idle state and being associated with a particular core network node identifier, and
(b) using, by the second core network node, the particular core network node identifier after the taking over of the mobility management and the bearer management without notifying the at least one mobile terminal of an update of the particular core network node identifier.

In a fifth example aspect, a method performed by a control node coupled to a core network includes when mobility management and bearer management of at least one mobile terminal, in an idle state and associated with a particular core network node identifier, are transferred from a first core network node to a second core network node, instructing a base station to change a forwarding destination of a Non-Access Stratum (NAS) message from the first core network node to the second core network node, the NAS message being transmitted by each of the at least one mobile terminal and being addressed to the particular core network node identifier.

In a sixth example aspect, a base station includes a memory and a processor coupled to the memory and configured to perform the method according to the above-described second example aspect.

In a seventh example aspect, a first core network node includes a memory and a processor coupled to the memory and configured to perform the method according to the above-described third example aspect.

In an eighth example aspect, a second core network node includes a memory and a processor coupled to the memory and configured to perform the method according to the above-described fourth example aspect.

In a ninth example aspect, a control node includes a memory and a processor coupled to the memory and configured to perform the method according to the above-described fifth example aspect.

In a tenth example aspect, a program includes a set of instructions (software codes) that, when loaded into a computer, causes the computer to perform the method according to any one of the above-described second to fifth example aspects.

### Advantageous Effects of Invention

According to the above-described example aspects, it is possible to provide a device, a method, and a program that contribute to preventing occurrences of signaling involving a mobile terminal when mobility management and bearer management of at least one mobile terminal (e.g., UE) in the idle state (e.g., in RRC_IDLE state and in ECM-IDLE state) are transferred between core network nodes (e.g., MMEs).

### BRIEF DESCRIPTION OF DRAWINGS

FIG. 1 is a view showing a configuration example of a mobile communication network according to an illustrative embodiment of the invention.

FIG. 2A is a conceptual diagram for describing an operation in a base station (before transfer of mobility management and bearer management) according to an illustrative embodiment of the invention.

FIG. 2B is a conceptual diagram for describing an operation in a base station (after transfer of mobility management and bearer management) according to an illustrative embodiment of the invention.

FIG. 3 is a sequence chart showing an example of a transfer procedure of mobility management and bearer management according to an illustrative embodiment of the invention.

FIG. 4 is a sequence chart showing a specific example of a transfer procedure of mobility management and bearer management according to an illustrative embodiment of the invention.

FIG. 5 is a sequence chart showing a specific example of a transfer procedure of mobility management and bearer management according to an illustrative embodiment of the invention.

FIG. 6 is a sequence chart showing a specific example of a transfer procedure of mobility management and bearer management according to an illustrative embodiment of the invention.

FIG. 7A is a conceptual diagram for describing an operation in a base station (before transfer of mobility management and bearer management) according to an illustrative embodiment of the invention.

FIG. 7B is a conceptual diagram for describing an operation in a base station (after transfer of mobility management and bearer management) according to an illustrative embodiment of the invention.

FIG. 8A is a conceptual diagram for describing an operation in a base station (before transfer of mobility management and bearer management) according to an illustrative embodiment of the invention.

FIG. 8B is a conceptual diagram for describing an operation in a base station (after transfer of mobility management and bearer management) according to an illustrative embodiment of the invention.

FIG. 9 is a sequence chart showing a specific example of a transfer procedure of mobility management and bearer management according to an illustrative embodiment of the invention.

FIG. 10 is a view showing a specific example of a format of an S1AP: S1 SETUP RESPONSE message.

FIG. 11 is a view showing a specific example of a format of an S1AP: MME CONFIGURATION UPDATE message.

FIG. 12 is a view showing an example of a data structure of MME TEID for S11 according to an illustrative embodiment of the invention.

FIG. 13 is a conceptual diagram for describing an operation in which a S11 connection is updated in an S-GW according to an illustrative embodiment of the invention.

FIG. 14 is a sequence chart showing a specific example of a transfer procedure of mobility management and bearer management according to an illustrative embodiment of the invention.

FIG. 15 is a block diagram showing a configuration example of an eNodeB according to an illustrative embodiment of the invention.

FIG. 16 is a block diagram showing a configuration example of an MME according to an illustrative embodiment of the invention.

FIG. 17 is a block diagram showing a configuration example of a control node according to an illustrative embodiment of the invention.

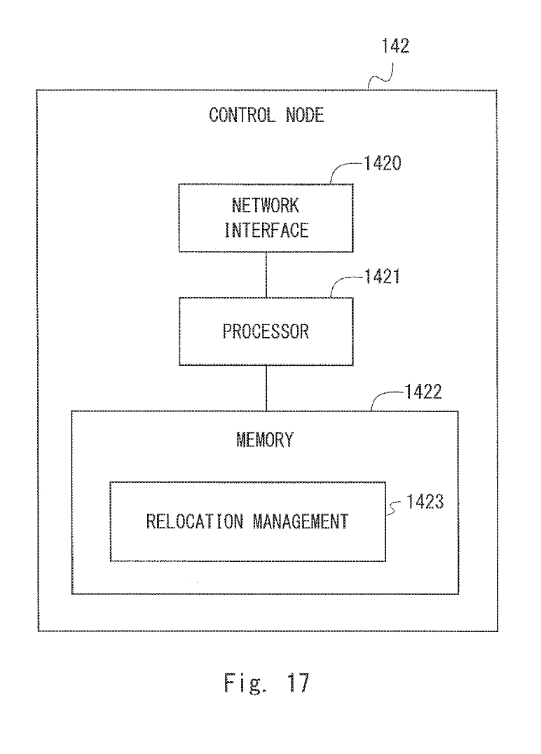

### DESCRIPTION OF EMBODIMENTS

Specific illustrative embodiments will be described hereinafter in detail with reference to the drawings. The same or corresponding elements are denoted by the same symbols throughout the drawings, and repetitive explanations will be omitted as necessary for the sake of clarity.

### First Illustrative Embodiment

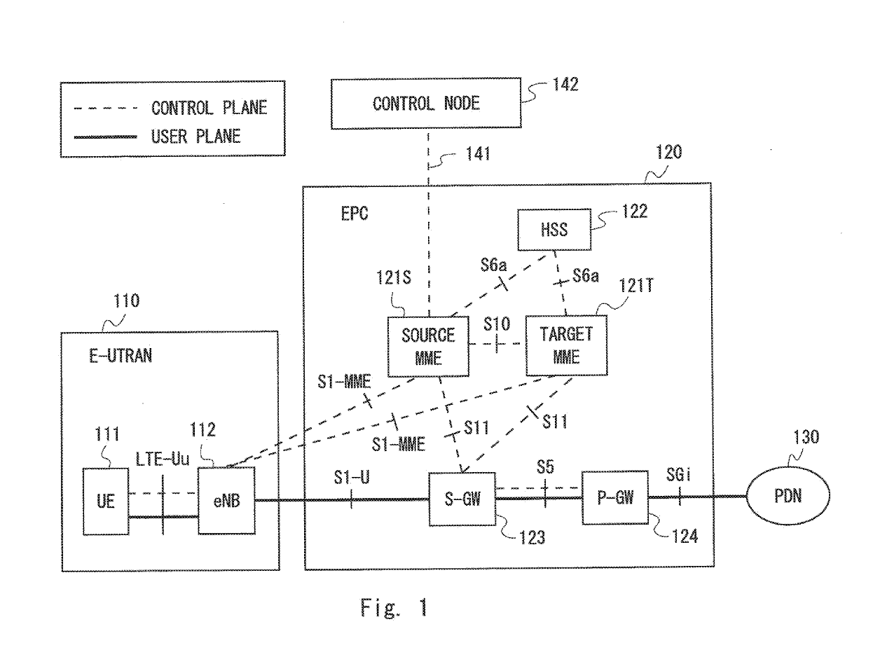

FIG. 1 shows a configuration example of a mobile communication network according to an illustrative embodiment. The mobile communication network provides communication services, such as voice communication or packet data communication or both, for example. In this illustrative embodiment, it is assumed that the mobile communication network is an EPS (i.e., Long Term Evolution (LTE) system or LTE-Advanced system).

The network shown in FIG. 1 includes an E-UTRAN 110 and an EPC 120. The E-UTRAN 110 includes a mobile terminal (User Equipment (UE)) 111 and a base station (eNodeB) 112. The EPC 120 includes a source MME 121S, a target MME 121T, a Home Subscriber Server (HSS) 122, an S-GW 123, and a P-GW 124.

The source MME 121S, the target MME 121T and the HSS 122 are nodes or entities in the control plane. The source MME 121S and the target MME 121T can perform mobility management and bearer management of a plurality of UEs including the UE 111. As described earlier, mobility management is used to keep track of the current location of a UE and includes maintaining a mobility management context (MM context) related to the UE. Bearer management includes controlling an establishment of an EPS bearer and maintaining an EPS bearer context for the UE. The HSS 122 manages subscriber information of UEs including the UE 111.

The S-GW 123 and the P-GW 124 are packet transfer nodes in the user plane and operate to transfer user data (i.e., Internet Protocol (IP) packet). The S-GW 123 is a gateway with an E-UTRAN 110 and is connected to an eNodeB 112 via an S1-U interface. The P-GW 124 is a gateway with a Packet Data Network (PDN) 130 and is connected to the PDN 130 via an SGi interface. The PDN 130 may be an external network such as the Internet or may be a network for an IP service (e.g., IP Multimedia Subsystem (IMS) service) provided by an operator that manages the EPC 120.

The source MME 121S may be connected to a control node 142 located outside the EPC 120 via a control interface 141. The control node 142 is, for example, an SDN controller, an NFV controller, an OSS, an EMS, or any combination thereof.

Further, the source MME 121S is configured to transfer mobility management and bearer management of the UE 111 in the idle state (i.e., although the UE 111 is in an EMM-REGISTERED state, it is also in Radio Resource Control (RRC)_IDLE and EPS Connection Management (ECM)-IDLE states) to the target MME 121T regardless of whether the UE 111 has moved between cells or between tracking areas. The transfer (relocation) of mobility management and bearer management means that the target MME 121T, instead of the source MME 121S, maintains the MM context and the EPS Bearer context for the UE 111. The transfer of mobility management and bearer management may be started, for example, in response to a command from the control node 142. Additionally or alternatively, the transfer may be started on the initiative of the source MME 121S or the target MME 121T regardless of the command from the control node 142.

When mobility management and bearer management of the UE 111 in the idle state are transferred from the source MME 121S to the target MME 121, it is preferable to prevent the occurrences of signaling between the UE 111 in the idle state and the MMEs 121S and 121T. Accordingly, in this illustrative embodiment, the eNodeB 112, the source MME 121S, and the target MME 121T operate as follows.

The eNodeB 112 configures itself to change, from the source MME 121S to the target MME 121T, the forwarding destination of a NAS message that is transmitted by the UE 111 and is addressed to a particular core network node identifier (i.e., Globally Unique MME Identity (GUMMEI), MME Identifier (MMEI), or MME Code (MMEC)). The particular core network node identifier (i.e., GUMMEI, MMEI, or MMEC) is used to identify the destinations of uplink NAS messages transmitted by the UE 111. Thus, after completion of the transfer of mobility management and bearer management, the eNodeB 112 operates to forward NAS messages, received from the UE 111 and addressed to the particular core network node identifier (i.e., GUMMEI, MMEI, MMEC), to the target MME 121T and not to the source MME 121S. The GUMMEI, which is an example of the particular core network node identifier, is used to globally uniquely identify an MME and is composed of a Public Land Mobile Network Identifier (PLMN ID) and an MMEI. The MMEI is used to uniquely identify an MME within a PLMN and is composed of an MME Group Identifier (MMEGI) and an MMEC. The MMEC is an 8-bit code and is used to uniquely identify an MME within a MME group.

Specifically, during an RRC connection establishment procedure, the eNodeB 112 receives an RRC parameter indicating the core network node identifier (i.e., GUMMEI or MMEC) and also receives an initial NAS message (i.e., TAU Request message, Service Request message, Extended Service Request message, or Detach message) from the UE 111 in the idle state. Then the eNodeB 112 derives an MME corresponding to the particular core network node identifier extracted from the RRC parameter and transmits the initial NAS message to this MME. The eNodeB 112 derives the source MME 121S as the MME corresponding to the particular core network node identifier when the transfer of mobility management and bearer management has not yet been performed, and derives the target MME 121T as the MME corresponding to the particular core network node identifier when this transfer has been completed.

More specifically, in the case of TAU Request, the eNodeB 112 receives, from the UE 111, an RRC Connection Setup Complete message containing Registered MME information and also containing a TAU Request message during the RRC connection establishment procedure. The Registered MME information indicates the GUMMEI derived from a Globally Unique Temporary Identity (GUTI) configured in the UE 111. Next, the eNodeB 112 extracts the TAU Request message from the RRC Connection Setup Complete message, and determines that this GUMMEI contained in this RRC Connection Setup Complete message is associated with the GUMMEI of the target MME 121T. The eNodeB 112 thus selects the target MME 121T and redirects an S1AP: Initial UE Message containing the extracted TAU Request message to the target MME 121T.

In the case of a Service Request, during the RRC connection establishment procedure, the eNodeB 112 receives an RRC Connection Request message containing UE Identity and also receives an RRC Connection Setup Complete message containing a Service Request message (DedicatedInfoNAS IE). The UE Identity contained in the RRC Connection Request message indicates an SAE Temporary Mobile Subscriber Identity (S-TMSI) derived from the GUTI configured in the UE 111. The S-TMSI contains the MMEC. Next, the eNodeB 112 extracts the Service Request message from the RRC Connection Setup Complete message, and determines that the MMEC in the S-TMSI indicated by this RRC Connection Request message is associated with the target MME 121T. The eNodeB 112 thus selects the target MME 121T and redirects an S1AP: Initial UE Message containing the extracted Service Request message to the target MME 121T.

The eNodeB 112 may be instructed by the source MME 121S or the target MME 121T to change (redirect) the forwarding destination of NAS messages. Additionally or alternatively, the eNodeB 112 may be instructed by the control node 142 to change the forwarding destination of NAS messages.

When the source MME 121T transfers the mobility management and bearer management regarding the UE 111 to the target MME 121T, the source MME 121T also transfers the particular core network node identifier (e.g., GUMMEI) to the target MME 121T. After taking over the mobility management and bearer management of the UE 111, the target MME 121T continues to use the particular core network node identifier, which had been used by the source MME 121S. That is, in this illustrative embodiment, mobility management and bearer management can be transferred per particular core network node identifier (e.g., GUMMEI). In other words, the source MME 121S can collectively transfer, to the target MME 121T, the mobility management and bearer management of one or more UEs 111 in the idle state, which are associated with the particular core network node identifier (e.g., GUMMEI).

The above-described operation by the eNodeB 112 for redirecting the NAS message and the operation for transferring the particular core network node identifier (e.g., GUMMEI) from the source MME 121S to the target MME 121T contribute to transferring the mobility management and bearer management regarding the UE 111 in the idle state without notifying the UE 111 in the idle state of the update of the particular core network node identifier (e.g., GUMMEI, MMEC). If the UE 111 is to be notified of an occurrence of transfer of the mobility management and bearer management (i.e., MME change), much signaling including paging, an RRC connection establishment, and an S1 signaling connection establishment will be necessary to transmit a downlink NAS message. On the other hand, this illustrative embodiment can prevent this signaling from occurring, thereby reducing the load on the network.

In order to efficiently transfer mobility and bearer management per particular core network identifier (e.g., GUMMEI), each of the source MME 121S and the target MME 121T may be configured to perform the mobility management and bearer management by using multiple core network identifiers (e.g., GUMMEIs). For example, during an attach procedure or a TAU procedure regarding the UE 111, the source MME 121S may determine which one of the core network identifiers (e.g., GUMMEIs) is to be associated with this UE 111 based on an attribute or a type of this UE 111. Nowadays, various types of mobile terminals such as a smart phone and a Machine Type Communication (MTC) device are used. A MTC device is also referred to as a Machine-to-Machine (M2M) device. MTC devices are implemented in various types of devices including machines (e.g., vending machines, gas meters, electricity meters, automobiles, railroad vehicles) and sensors (e.g., environmental, agricultural, or traffic sensors). These various types of mobile terminals are considered to have different purposes of use, different communication characteristics, or different mobility characteristics from one another. Therefore, associating mobile terminals having attributes and types different from one another with different core network identifiers may contribute to efficient mobility management and bearer management. Alternatively, during an attach procedure or a TAU procedure of the UE 111, the source MME121S may randomly associate one of multiple core network identifiers (e.g., GUMMEIs) with this UE 111 or may determine a core network identifier to be associated with this UE 111 based on a time or an order of this attach.

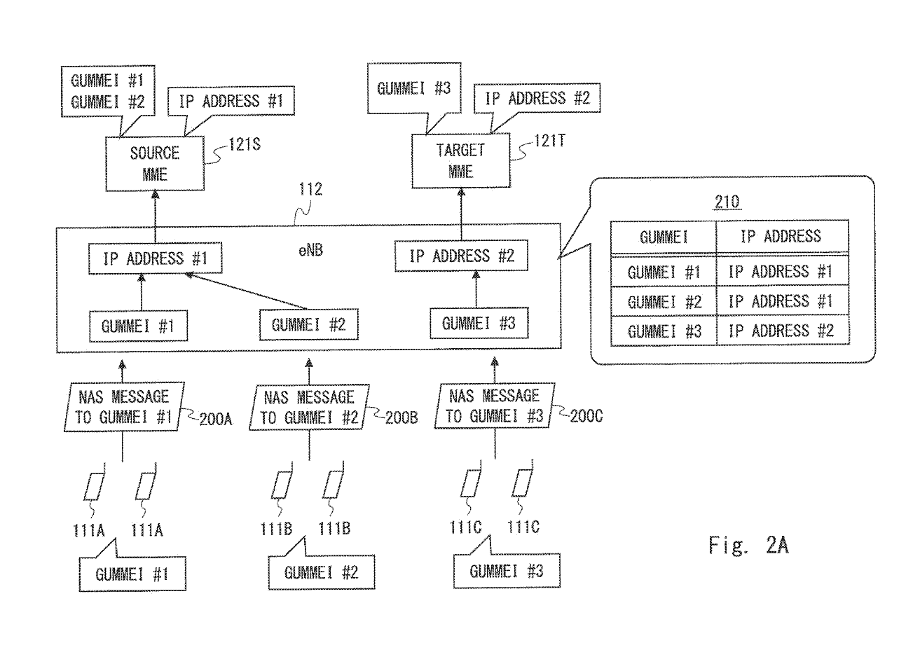

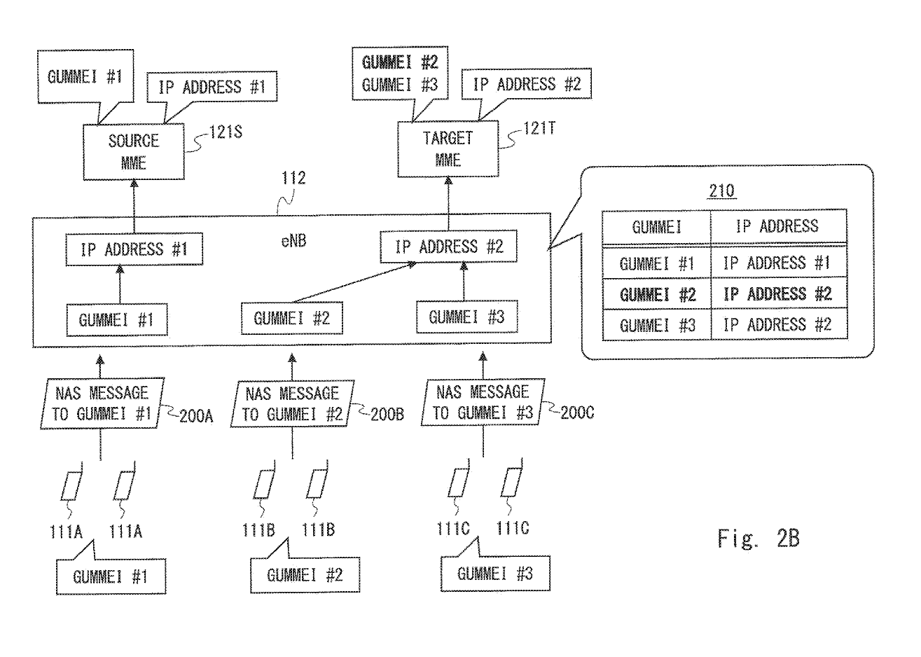

The following describes a specific example of the operation in the eNodeB 112 according to this illustrative embodiment in detail with reference to FIGS. 2A and 2B. FIG. 2A shows a network state before transfer of mobility management and bearer management is performed. In the example of FIG. 2A, the source MME 121S uses two GUMMEIs, i.e., GUMMEI #1 and GUMMEI #2, to manage a plurality of UEs 111A and a plurality of UEs 111B. On the other hand, the target MME 121T uses one GUMMEI, i.e., GUMMEI #3, to manage a plurality of UEs 111C. The source MME 121S and the target MME121T use an IP address #1 and an IP address #2 for packet transfer with the eNodeB 112.

Each UE 111A in the idle state is associated with the GUMMEI #1 and is allocated a GUTI (i.e., GUMMEI #1+M-TMSI) containing the GUMMEI #1. Each UE 111B in the idle state is associated with the GUMMEI #2 and is allocated a GUTI (i.e., GUMMEI #2+M-TMSI) containing the GUMMEI #2. Likewise, each UE 111C in the idle state is associated with the GUMMEI #3 and is allocated a GUTI (i.e., GUMMEI #3+M-TMSI) containing the GUMMEI #3.

Further, in the example of FIG. 2A, the eNodeB 112 holds a transfer table 210. The transfer table 210 is used by the eNodeB 112 to determine an MME to which an uplink NAS message is to be forwarded. As shown in FIG. 2A, the transfer table 210 may associate each GUMMEI with the corresponding MME's IP address used for data packet transfer. The eNodeB 112 forwards uplink NAS messages 200A and uplink NAS messages 200B received from the UEs 111A and UEs 111B to the IP address #1 (i.e., the source MME 121S), and transfers uplink NAS messages 200C received from the UEs 111C to the IP address #2 (i.e., the target MME 121T), in accordance with the transfer table 210.

On the other hand, FIG. 2B shows a network state after the mobility management and bearer management regarding the UEs 111B associated with the GUMMEI #2 are transferred from the source MME 121S to the target MME 121T. Accordingly, in the example of FIG. 2B, the source MME 121S uses one GUMMEI, i.e., the GUMMEI #1, to manage the plurality of UEs 111A. On the other hand, the target MME 121T uses two GUMMEIs, i.e., the GUMMEI #2 and GUMMEI #3, to manage the plurality of UEs 111B and the plurality of UEs 111C. Further, upon the completion of the transfer of the mobility management and bearer management regarding the GUMMEI #2, the transfer table 210 held in the eNodeB 112 has been updated. That is, in the transfer table 210 shown in FIG. 2B, the IP address of the target MME 121T (IP address #2) is associated with the GUMMEI #2. Thus, the eNodeB 112 transfers uplink NAS messages 200A received from the UEs 111A to the IP address #1 (i.e., the source MME 121S), and transfers uplink NAS messages 200B and uplink NAS messages 200C received from the UEs 111B and the UEs 111C to the IP address #2 (i.e., the target MME 121T).

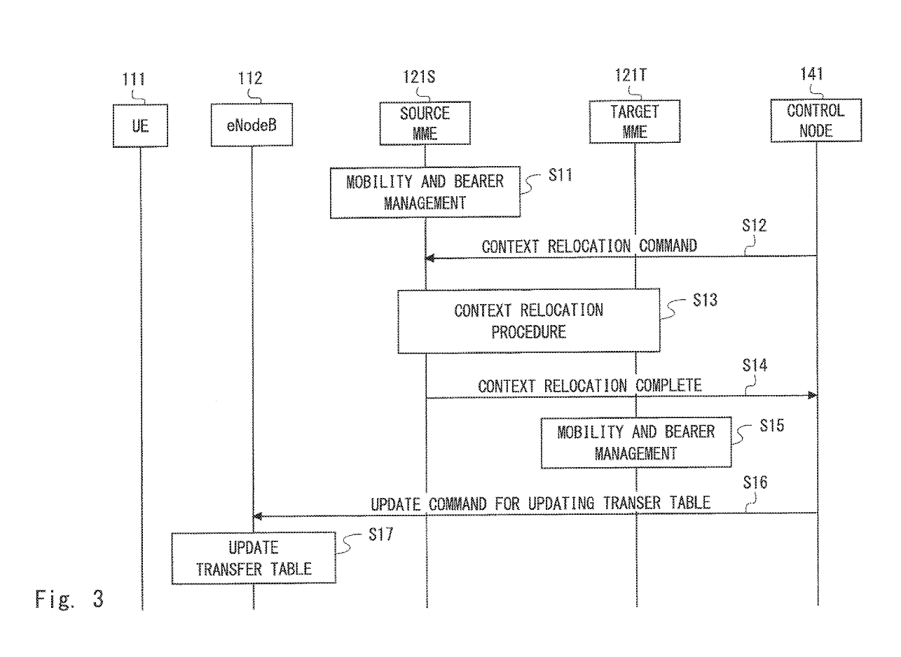

Hereinafter, some specific examples of the procedure for transferring mobility management and bearer management will be described. FIG. 3 is a sequence chart showing an example of the transfer procedure. In Step S11, the source MME 121S performs mobility management and bearer management of at least one UE 111 that is in the idle state.

In Step S12, the control node 142 transmits a Context Relocation Command message to the source MME 121S. The Relocation Command message causes transfer (relocation) of mobility management and bearer management from the source MME 121S to at least one target MME 121T. The Relocation Command message contains a relocation policy indicating an identifier of at least one target MME 121T. The identifier of the target MME 121T may be, for example, a GUMMEI, an MMEI, or an MMEC.

The relocation policy may also indicate the processing amount of mobility management and bearer management to be transferred from the source MME 121S to at least one target MME 121T. The processing amount of mobility management and bearer management may be indicated by the number of UEs, the amount of use of processor resources, the amount of use of memory resources, the number of occurrences of signaling, the amount of traffic, or any combination thereof. Additionally or alternatively, the relocation policy may indicate the particular core network node identifier(s) (i.e., GUMMEI, MMEI, or MMEC), for which transfer (relocation) is to be performed. The relocation policy may indicate temporal constraints on the transfer of mobility management and bearer management. To be specific, the relocation policy may indicate the start time of the transfer, the end time of the transfer, or the period during which execution of the transfer is allowed.

Referring back to FIG. 3, in Step S13, the source MME 121S initiates the procedure for transferring mobility management and bearer management to the target MME 121T in accordance with the relocation policy indicated by the Relocation Command message. Specific examples of this procedure are described later. In Step S14, the source MME 121S transmits to the control node 142 a Context Relocation Complete message indicating the completion of the relocation. In Step S15, the target MME 121T performs the mobility management and bearer management, which have been taken over from the source MME 121S, related to the UE 111.

In Step S16, the control node 142 instructs the eNodeB 112 to update the transfer table (e.g., the transfer table 210 shown in FIGS. 2A and 2B) for determining the MME to which an uplink NAS message is to be forwarded. Although it is not shown in FIG. 3, the control node 142 may transmit the update command (Step S16) to all of the eNodeBs 112 that are associated with (i.e., each have an S1-MME connection with) the MME pool area to which both the source MME 121S and the target MME 121T belong. In Step S17, the eNodeB 112 updates the transfer table in accordance with the command from the control node 142.

The transfer procedure of the mobility management and bearer management shown in FIG. 3 is merely an example and may be changed as appropriate. For example, the update command for the transfer table to the eNodeB 112 (Step S15) may be transmitted before the Relocation Command (Step S12) is transmitted to the source MME 121S or may be transmitted temporally in parallel to the Relocation Command (Step S12) or the relocation procedure (Step S13) performed following the Relocation Command.

Further, as mentioned earlier, the source MME 121S or the target MME 121T may autonomously initiate the transfer procedure (Step S13) of mobility management and bearer management regardless of the command (Step S12) from the control node 142.

The procedure for transferring mobility management and bearer management from the source MME 121S to the target MME 121T may involve an S-GW relocation (or S-GW change). The S-GW relocation means changing, from the S-GW 123 to another S-GW, the route of the EPS bearer (i.e., termination points of S1 and S5/S8 bearers) for the UE 111 that has been managed by the source MME 121S.

In one example, the target MME 121T may autonomously select an S-GW based on the S-GW selection function implemented therein. Alternatively, the control node 142 may select an S-GW as the destination of the relocation (which is referred to as a target S-GW). Specifically, the control node 142 may add the designation of the target S-GW to the Context Relocation Command message to be transmitted to the source MME 121S. In this case, in the transfer (relocation) procedure (Step S13 in FIG. 3) of mobility management and bearer management, the source MME 121S may inform the target MME 121T about the address of the target S-GW.

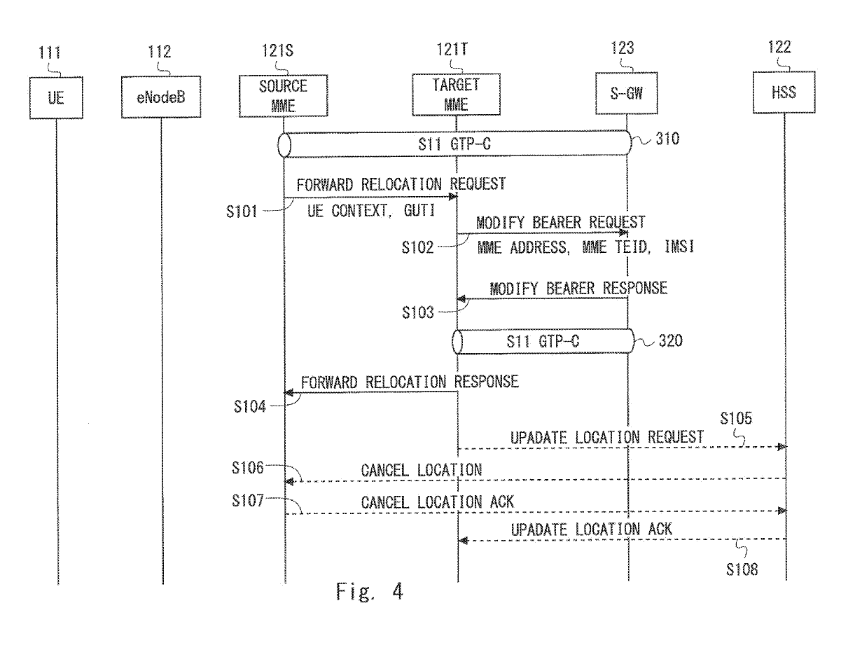

FIG. 4 shows a specific example of the procedure for transferring the mobility management and bearer management regarding the UE 111 from the source MME 121S to the target MME 121T. The procedure shown in FIG. 4 can be performed in Step S13 of FIG. 3. Thus, the source MME 121S may initiate the procedure shown in FIG. 4 in response to receiving the Relocation Command message from the control node 142. The procedure shown in FIG. 4 is initiated when the UE 111 is in the idle state (e.g., in RRC_IDLE state and in ECM IDLE state).

At the time of initiation of the procedure shown in FIG. 4, the source MME 121S has a signaling connection (i.e., S11 GPRS Tunnelling Protocol for the Control Plane (GTP-C) connection 310) with the S-GW 123 for management of the EPS bearer for the UE 111. In Step S101, the source MME 121S transmits the mobility management context (MM context) and the bearer management context (EPS bearer context) for the UE 111 to the target MME 121T, and also transmits the particular GUMMEI associated with the UE 111 (e.g., the GUMMEI #2 shown in FIGS. 2A and 2B) to the target MME 121T. The particular GUMMEI may be transmitted as the GUTI allocated to the UE 111. The GUTI allocated to the UE 111 is composed of the particular GUMMEI and the M-TMSI.

In Step S101, a GTP-C message transmitted on an S10 interface between MMEs may be used for transmission of the MM context, EPS bearer context, and GUTI. For example, as shown in FIG. 4, a Forward Relocation Request message or a modification thereof may be used. The Forward Relocation Request message is transmitted from a source MME to a target MME in the S1-based handover procedure. The Forward Relocation Request message in Step S101 may contain an information element indicating that it is a message transmitted for a Context Relocation, not for an S1-based handover. In place of the Forward Relocation Request message, a new message containing the MM context and EPS bearer context for the plurality of UEs 111 associated with the particular GUMMEI may be used.

In Step S102, the target MME 121T stores the MM context and EPS bearer context for the UE 111, which have been received from the source MME 121S, in its memory or storage (not shown). Further, in response to receiving the MM context and EPS bearer context for the UE 111, the target MME 121T requests the S-GW 123 to change, from the source MME 12S to the target MME 121T, the termination point of the S11 GTP-C connection for the EPS bearer management of the UE 111. This request indicates the IP address and MME Tunnel endpoint identifier (MME TEID) of the target MME 121T. This request further includes an International Mobile Subscriber Identity (IMSI) or an EPS Bearer ID or both in order to identify the target UE 111. For the transmission of this request, a GTP-C message transmitted on the S11 interface between the MME 121T and the S-GW 123 may be used. For example, as shown in FIG. 4, a Modify Bearer Request message or a modification thereof may be used.

In Step S103, the S-GW 123 updates the MME IP address and the MME TEID associated with the EPS bearer context for the UE 111 and transmits a response message (e.g., Modify Bearer Response message) to the target MME 121T. Thus, an S11 GTP-C connection 320 for management of the EPS bearer of the UE 111 is established between the target MME 121T and the S-GW 123.

In Step S104, the target MME 121T informs the source MME 121S that it has accepted the transfer of the mobility management and bearer management of the UE 111. For the transmission of this notification, a GTP-C message that is transmitted on the S10 interface between MMEs may be used. For example, as shown in FIG. 4, a Forward Relocation Response message or a modification thereof may be used. Alternatively, a Forward Relocation Complete Notification message or a modification thereof may be used.

Steps S105 to S108 are performed to notify the HSS 122 of a MME change. The procedure performed in Steps S105 to S108 may be the same as the procedure to notify an HSS of an MME change in a normal TAU procedure. Alternatively, the HSS 122 may be notified of an MME change in a normal TAU procedure (periodic TAU) that is performed after the completion of the procedure shown in FIG. 4. Thus, Steps S105 to S108 may be omitted.

In Step S105, the target MME 121T transmits a message for informing the HSS 122 about the MME change related to the UE 111. For the transmission of this message, a Diameter message that is transmitted on the S6a interface between the MME 121T and the HSS 122 may be used. As shown in FIG. 4, an Update Location Request message may be used, like in a normal TAU procedure. In Step S106, the HSS 122 transmits a Cancel Location message to the source MME 121S to notify it that the MM context and EPS bearer context for the UE 111 can be deleted. The Cancel Location message indicates the IMSI of the UE 111. In Step S107, the source MME 121S deletes the MM context and EPS bearer context for the UE 111 according to need. Then, the source MME 121S transmits a Cancel Location Ack message to the HSS 122. The Cancel Location Ack message indicates the IMSI of the UE 111. In Step S108, the HSS 122 acknowledges the Update Location Request and transmits an Update Location Ack message to the target MME 121T.

By using the procedures shown in FIGS. 3 and 4, the transfer (relocation) of the mobility management and bearer management regarding the UE 111 in the idle state can be completed without involving signaling with the UE 111.

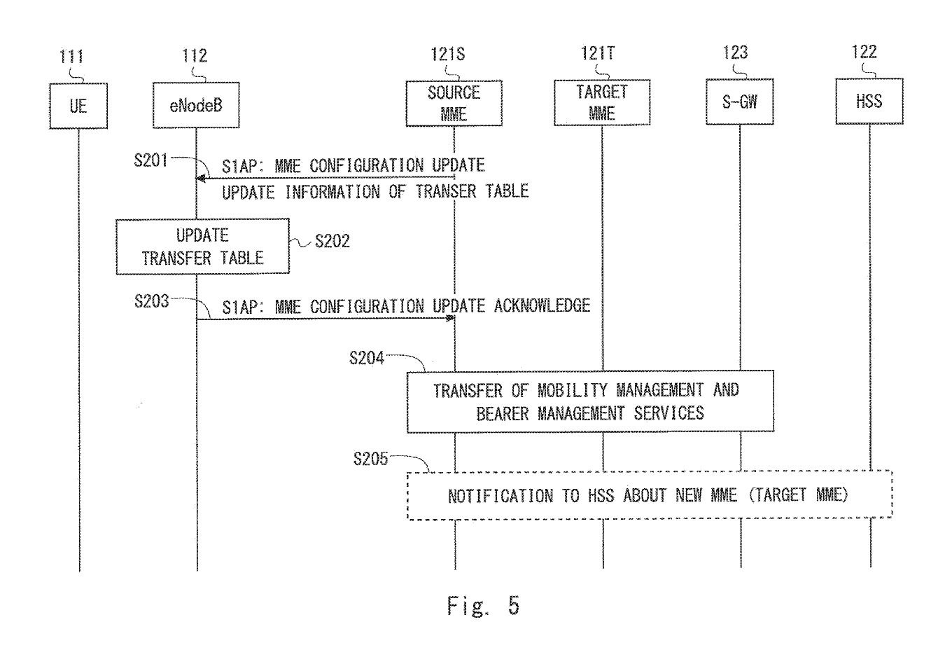

FIG. 5 shows another example of the procedure for transferring the mobility management and bearer management regarding the UE 111. In the example of FIG. 5, the source MME 121S, instead of the control node 142, instructs the eNodeB 112 to change the forwarding destination of uplink NAS messages. Specifically, the source MME 121S may instruct the eNodeB 112 to update the transfer table (e.g., the table 210 shown in FIGS. 2A and 2B).

Steps S201 to S203 show the operation for updating the transfer table held in the eNodeB 112. In Step S201, the source MME 121S transmits an update command for the transfer table to the eNodeB 112. This update command includes update information of the transfer table. For the transmission of this update command, an S1AP message transmitted on the S1-MME interface between the MME 121S and the eNodeB 112 may be used. For example, as shown in FIG. 5, one of the existing S1AP messages (e.g., MME Configuration Update message) or a modification thereof may be used. Alternatively, a newly defined S1AP message (e.g., S1AP Redirection Command message) may be used.

In Step S202, the eNodeB 112 updates the transfer table in such a way that uplink NAS messages addressed to the particular GUMMEI are forwarded to the target MME 121T in accordance with the update command from the source MME 121S. In Step S203, the eNodeB 112 transmits to the source MME 121S an S1AP message (e.g., MME Configuration Update Acknowledge message) for notifying the source MME 121S of the receipt of the update command.

In Step S204, the source MME 121S transfers, to the target MME 121T, the mobility management and bearer management regarding at least one UE 111 that is in the idle state and is associated with the particular GUMMEI. The procedure performed in Step S204 may be the same as the procedure performed in Steps S101 to S104 in FIG. 4.

In Step S205, the target MME 121T notifies the HSS 122 of the MME change. The procedure performed in Step S205 may be the same as the procedure for notifying the HSS of the MME change in a normal TAU procedure, that is, it may be the same as the procedure performed in Steps S105 to S108 in FIG. 4. Step S205 may be omitted, like Steps S105 to S108 in FIG. 4 described above.

The procedure in FIG. 5 may be changed as appropriate. For example, Steps S201 to S203 for updating the transfer table held in the eNodeB 112 may be performed after the transfer of mobility management and bearer management (step S204).

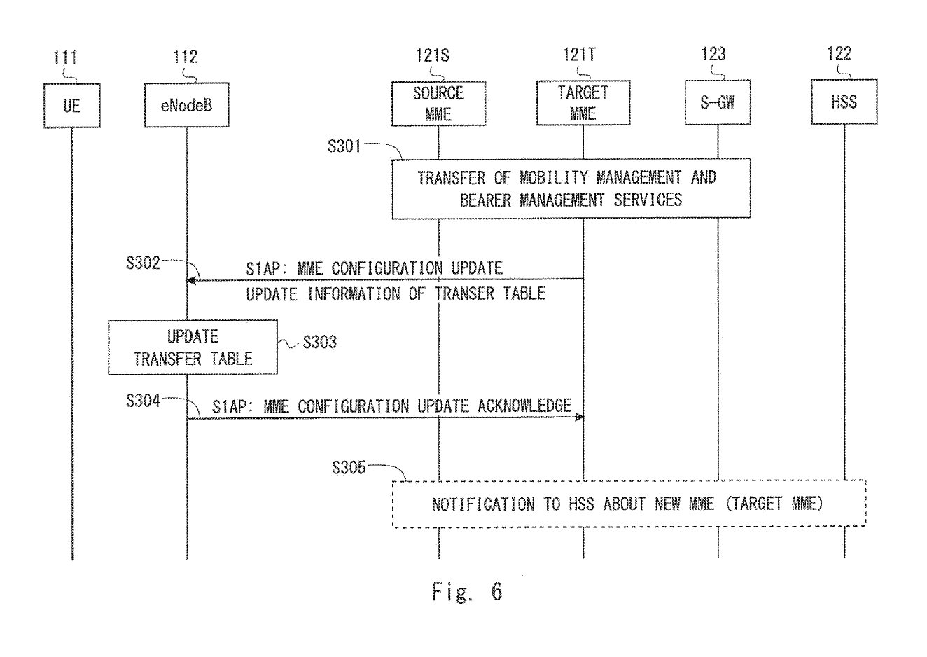

FIG. 6 shows another example of the procedure for transferring the mobility management and bearer management of the UE 111. In the example of FIG. 6, the target MME 121T, instead of the control node 142, instructs the eNodeB 112 to change the forwarding destination of uplink NAS messages addressed to the particular GUMMEI, for which the transfer has been performed, from the source MME 121S to the target MME 121T. Specifically, the target MME 121T may instruct the eNodeB 112 to update the transfer table (e.g., the transfer table 210 shown in FIGS. 2A and 2B).

In Step S301, the source MME 121S transfers, to the target MME 121T, the mobility management and bearer management regarding at least one UE 111 that is in the idle state and associated with the particular GUMMEI. The procedure performed in Step S301 may be the same as the procedure performed in Steps S101 to S104 in FIG. 4.

Steps S302 to S304 show the operation for updating the transfer table held in the eNodeB 112. In Step S302, the target MME 121T transmits an update command for the transfer table to the eNodeB 112. This update command includes update information of the transfer table. For the transmission of this update command, an S1AP message transmitted on the S1-MME interface between the MME 121T and the eNodeB 112 (i.e., MME Configuration Update message) or a modification thereof or a newly defined S1AP message may be used. In Step S303, the eNodeB 112 updates the transfer table in such a way that uplink NAS messages addressed to the particular GUMMEI are forwarded to the target MME 121T in accordance with the update command from the target MME 121T. In Step S304, the eNodeB 112 transmits to the target MME 121T an S1AP message (e.g., MME Configuration Update Acknowledge message) for notifying the target MME 121T of the receipt of the update command.

In Step S305, the target MME 121T notifies the HSS 122 of the MME change. The procedure performed in Step S305 may be the same as the procedure for notifying the HSS of the MME change in a normal TAU procedure, that is, it may be the same as the procedure performed in Steps S105 to S108 in FIG. 4. Step S305 may be omitted, like Steps S105 to S108 in FIG. 4 described above.

### Second Illustrative Embodiment

This illustrative embodiment provides a modified example of the configuration and operation for transferring mobility management and bearer management described in the first illustrative embodiment. A configuration example of the mobile communication network according to this illustrative embodiment may be the same as that shown in FIG. 1, which is described in relation to the first illustrative embodiment.

In the above-described first illustrative embodiment, the example in which the source MME 121S and the target MME 121T each use multiple GUMMEIs to perform mobility management and bearer management has been described. However, when one MME uses multiple GUMMEIs, it may be inconvenient, for example, if a GUMMEI is used for Operation and Maintenance (OAM), signaling between MMEs, or signaling between an MME and an S-GW. For this reason, in this illustrative embodiment, s virtual GUMMEI (V-GUMMEI) are used. The V-GUMMEI is allocated to a terminal group including at least one UE 111. Each of the source MME 121S and the target MME 121T according to this illustrative embodiment is configured to perform mobility management and bearer management using multiple V-GUMMEIs. The source MME 121S transfers the mobility management and bearer management to the target MME 121T per V-GUMMEI.

Each of the source MME 121S and the target MME 121T is allocated a unique (normal) GUMMEI to differentiate it from other MMEs. This unique (normal) GUMMEI is referred to as a Real GUMMEI (R-GUMMEI) in this illustrative embodiment. The terms “V-GUMMEI” and “R-GUMMEI” are merely an example. If the R-GUMMEI corresponds to the existing GUMMEI used for transfers on the S1-MME (S1-C) interface, the V-GUMMEI may be referred to as a Temporary GUMMEI (T-GUMMEI) or a Logical GUMMEI (L-GUMMEI). Alternatively, the R-GUMMEI and the V-GUMMEI may be simply referred to as a first GUMMEI and a second GUMMEI, respectively.

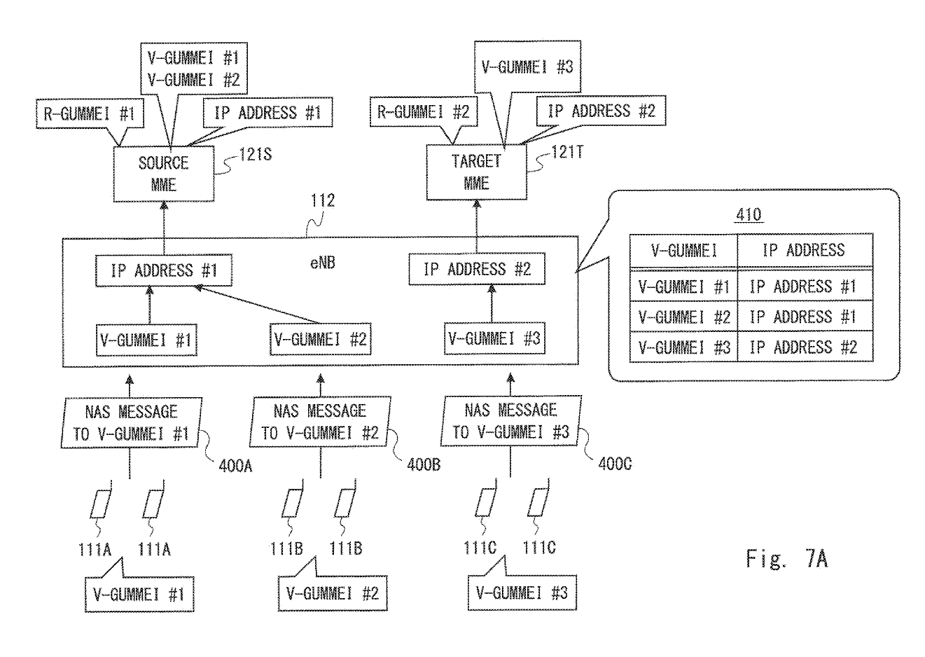

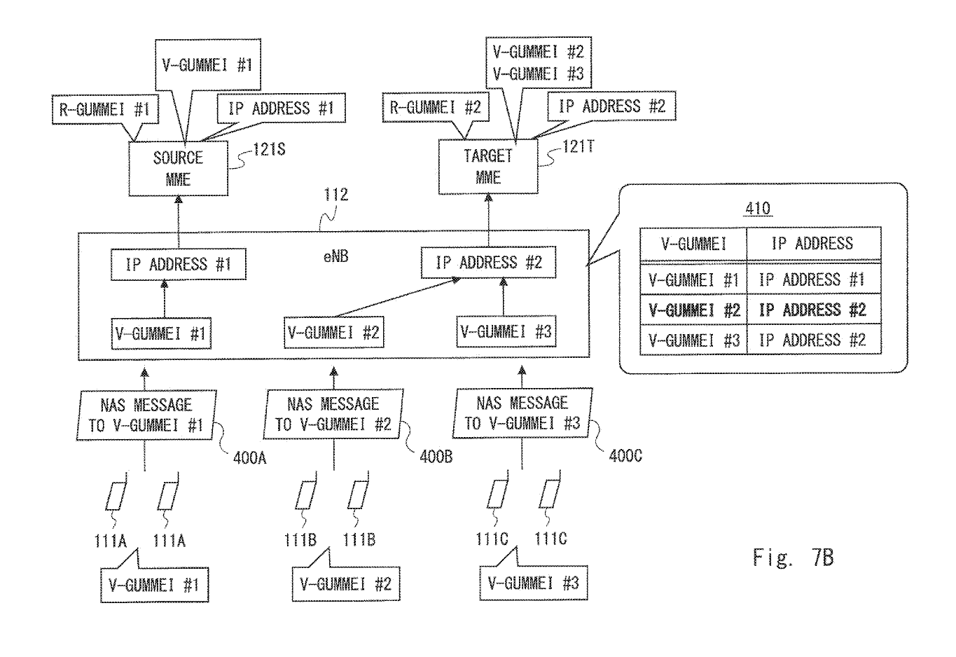

A specific example of the operation in the eNodeB 112 according to this illustrative embodiment will be described with reference to FIGS. 7A and 7B. As is obvious from the comparison between FIGS. 7A and 7B and FIGS. 2A and 2B, the configuration and operation in the eNodeB 112 shown in FIGS. 7A and 7B are the same as those of the eNodeB 112 shown in FIGS. 2A and 2B except that the eNodeB 112 shown in FIGS. 7A and 7B includes a transfer table 420 related to V-GUMMEIs.

That is, FIG. 7A shows a network state before transfer of mobility management and bearer management is performed. In the example of FIG. 7A, the source MME 121S and the target MME 121T are configured with the R-GUMMEI #1 and the R-GUMMEI #2, respectively. The source MME 121S and the target MME 121T use the IP address #1 and the IP address #2, respectively, for packet transfer with the eNodeB 112. Further, the source MME 121S uses two V-GUMMEIs, i.e., V-GUMMEI #1 and V-GUMMEI #2, to manage the plurality of UEs 111A and the plurality of UEs 111B. On the other hand, the target MME 121T uses one V-GUMMEI, i.e., V-GUMMEI #3, to manage the plurality of UEs 111C.

Each UE 111A in the idle state is associated with the V-GUMMEI #1 and is allocated a Virtual GUTI (V-GUTI) (i.e., V-GUMMEI #1+M-TMSI) containing the V-GUMMEI #1. Each UE 111B in the idle state is associated with the V-GUMMEI #2 and is allocated a V-GUTI (i.e., V-GUMMEI #2+M-TMSI) containing the V-GUMMEI #2. Likewise, each UE 111C in the idle state is associated with the V-GUMMEI #3 and is allocated a V-GUTI (i.e., V-GUMMEI #3+M-TMSI) containing the V-GUMMEI #3.

In the example of FIG. 7A, the eNodeB 112 holds the transfer table 410. The transfer table 410 is used by the eNodeB 112 to determine an MME to which an uplink NAS message is to be forwarded. As shown in FIG. 7A, the transfer table 410 may associate each V-GUMMEI with the corresponding MMEs IP address used for data packet transfer. The eNodeB 112 transfers uplink NAS messages 400A and uplink NAS messages 400B received from the UEs 111A and UEs 111B to the IP address #1 (i.e., the source MME 121S), and transfers uplink NAS messages 400C received from the UEs 111C to the IP address #2 (i.e., the target MME 121T), in accordance with the transfer table 410.

On the other hand, FIG. 7B shows a network state after the mobility management and bearer management of the UEs 111B associated with the V-GUMMEI #2 are transferred from the source MME 121S to the target MME 121T. Accordingly, in the example of FIG. 7B, the source MME 121S uses one V-GUMMEI, i.e., the V-GUMMEI #1, to manage the plurality of UEs 111A. On the other hand, the target MME 121T uses two V-GUMMEIs, i.e., the V-GUMMEI #2 and V-GUMMEI #3, to manage the plurality of UEs 111B and the plurality of UEs 111C. Upon the completion of the transfer of the mobility management and bearer management regarding the V-GUMMEI #2, the transfer table 410 held in the eNodeB 112 has been updated. That is, in the transfer table 410 shown in FIG. 7B, the IP address of the target MME 121T (IP address #2) is associated with the V-GUMMEI #2. Thus, the eNodeB 112 transfers uplink NAS messages 400A received from the UEs 111A to the IP address #1 (i.e., the source MME 121S), and transfers uplink NAS messages 400B and uplink NAS messages 400C received from the UEs 111B and the UEs 111C to the IP address #2 (i.e., the target MME 121T).

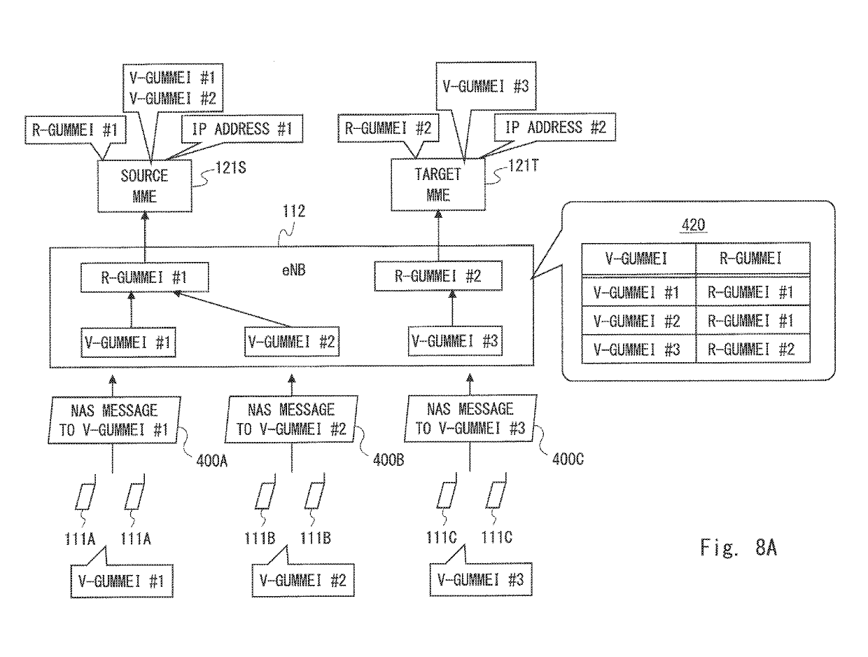

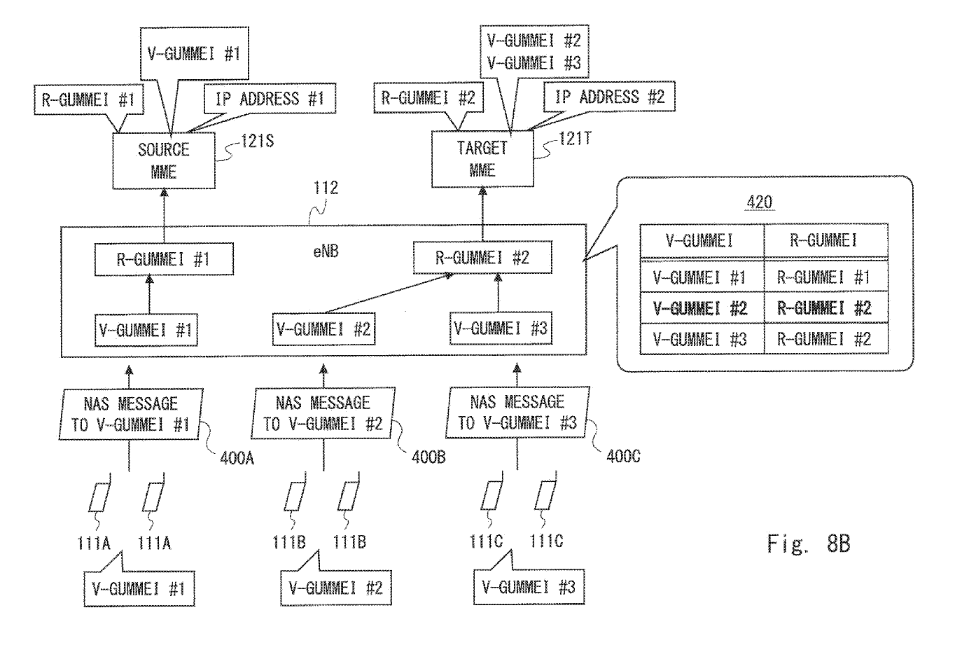

As shown in FIGS. 8A and 8B, the eNodeB 112 according to this illustrative embodiment may include a transfer table indicating associations between V-GUMMEIs and R-GUMMEIs for transferring uplink NAS messages. Like FIG. 7A, FIG. 8A shows a network state before transfer of mobility management and bearer management is performed. The eNodeB 112 shown in FIG. 8A holds a transfer table 420. The transfer table 420 indicates associations between V-GUMMEIs and R-GUMMEIs. The eNodeB 112 transfers the uplink NAS messages 400A and the uplink NAS messages 400B received from the UEs 111A and UEs 111B to the MME having the R-GUMMEI #1 (i.e., source MME 121S), and transfers the uplink NAS messages 400C received from the UEs 111C to the MME having the R-GUMMEI #2 (i.e., target MME 121T), in accordance with the transfer table 420.

On the other hand, like FIG. 7B, FIG. 8B shows a network state after the mobility management and bearer management regarding the UEs 111B associated with the V-GUMMEI #2 are transferred from the source MME 121S to the target MME 121T. As shown in FIG. 8B, upon the completion of the transfer of the mobility management and bearer management regarding the V-GUMMEI #2, the transfer table 420 held in the eNodeB 112 has been updated. That is, in the transfer table 420 shown in FIG. 8B, the R-GUMMEI (R-GUMMEI #2) of the target MME 121T is associated with the V-GUMMEI #2. Thus, the eNodeB 112 transfers the uplink NAS messages 400A received from the UEs 111A to the MME having the R-GUMMEI #1 (i.e., source MME 121S), and transfers the uplink NAS messages 400B and the uplink NAS messages 400C received from the UEs 111B and UEs 111C to the MME having the R-GUMMEI #2 (i.e., target MME 121T).

In the examples shown in FIGS. 8A and 8B, the eNodeB 112 may have an additional table indicating associations between the R-GUMMEIs and the IP addresses of the MMEs in order to resolve the names of the MMEs, that is, in order to retrieve the IP addresses of the MMEs. Alternatively, the eNodeB 112 may use a Domain Name System (DNS) service in order to resolve the names of the MMEs.

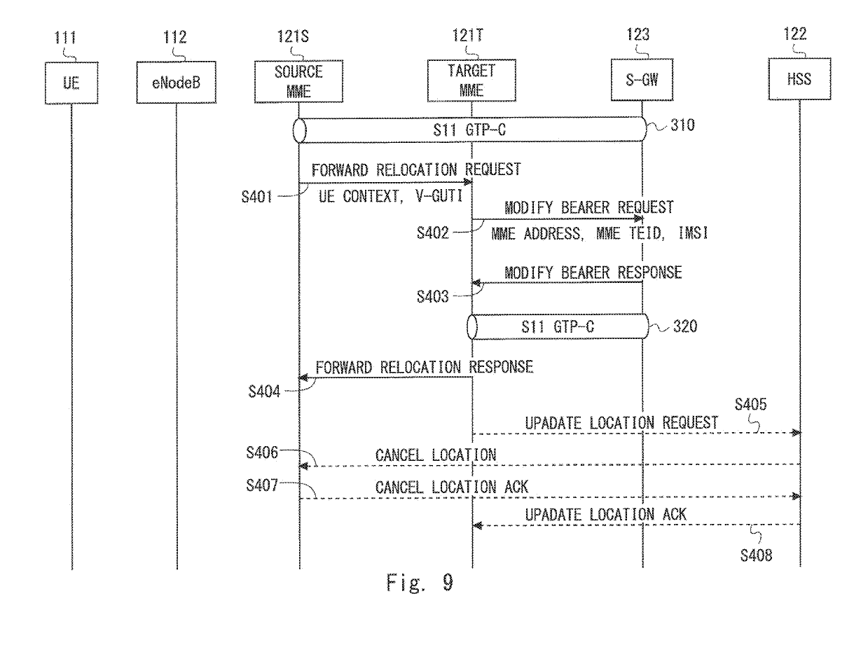

FIG. 9 shows a specific example of the procedure for transferring the mobility management and bearer management regarding the UE 111 from the source MME 121A to the target MME 121T. In Step S401, the source MME 121S transmits the mobility management context (MM context) and the bearer management context (EPS bearer context) for the UE 111 to the target MME 121T, and also transmits the particular V-GUMMEI associated with the UE 111 (e.g., V-GUMMEI #2 shown in FIGS. 7A and 7B) to the target MME 121T. The particular V-GUMMEI may be transmitted as the V-GUTI allocated to the UE 111. The V-GUTI allocated to the UE 111 is composed of the particular V-GUMMEI and the M-TMSI. The processing of Steps S402 to S408 in FIG. 9 may be the same as the processing of Steps S102 to S108 in FIG. 4 except that the V-GUMMEI is used instead of the GUMMEI. Thus, the description related to Steps S402 to S408 will be omitted for this case.

The procedure in FIG. 9 is merely an example. For example, the procedure described with reference to FIGS. 5 and 6 in the first illustrative embodiment, i.e., the procedure in which the source MME 121S or the target MME 121T instructs the eNodeB 112 to change the forwarding destination of uplink NAS messages, may be employed. If the procedure in FIG. 5 or 6 is employed, an S1AP: MME CONFIGURATION UPDATE (S201 in FIG. 5 and S302 in FIG. 6) may be used to update the transfer table 420 shown in FIGS. 8A and 8B. The updating of the transfer table 420 will be further described below.

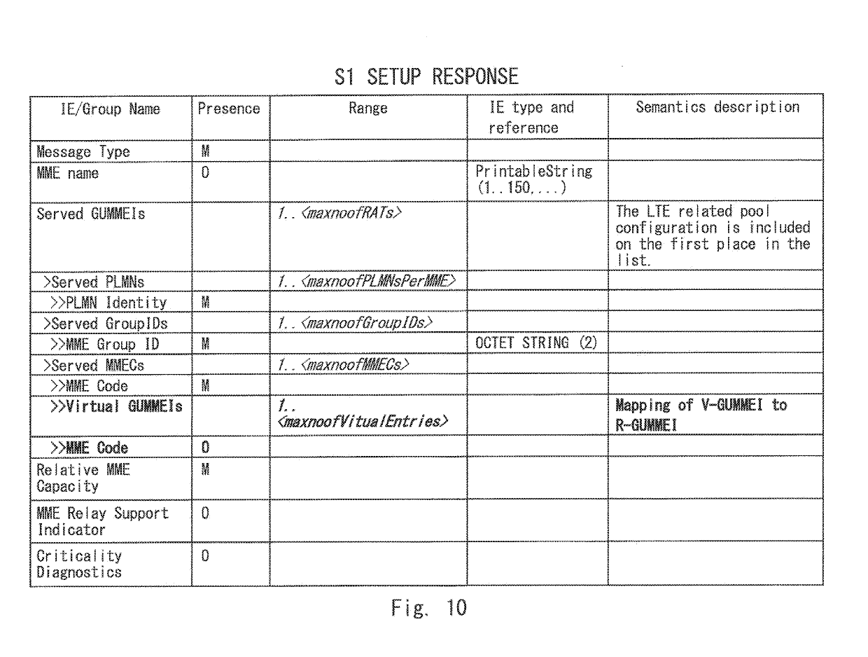

Firstly, the MME may notify the eNodeB of the information about the transfer table by using an S1AP: S1 SETUP RESPONSE message described in FIG. 10. The “maxnoofVirtualEntries” element means the maximum number of V-GUMMEIs that can be mapped to one R-GUMMEI. In the example of FIG. 10, the MME code, which corresponds to the eight least significant bits of the Served GUMMEI, is used for mapping between the R-GUMMEI and V-GUMMEIs. For example, when three V-GUMMEIs are mapped to one R-GUMMEI, three MME Codes (e.g. 0x00:00000000, 0x01:00000001, 0x02:00000010) may be allocated to one MME Code (e.g. 0x00:00000000) specified by the “Served MMECs” IE. At this time, the MME Codes used for the V-GUMMEIs are not used for R-GUMMEIs within the same MME group (i.e., the set of MMEs having the same PLMN and the same MMEGI). When the S1AP: S1 SETUP RESPONSE message includes an information element (“Virtual GUMMEIs” IE) indicating the mapping between V-GUMMEIs and R-GUMMEIs, the eNodeB 112 uses this IE to forward a NAS message, that is, to determine an MME to which a NAS message is to be forwarded.

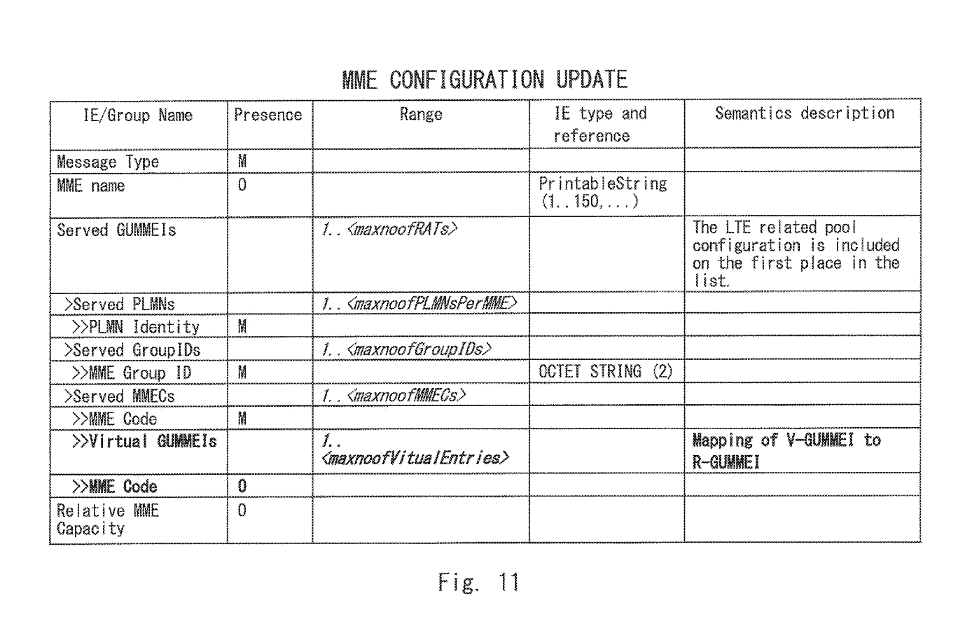

On the other hand, the S1AP: MME CONFIGURATION UPDATE message shown in FIGS. 5 and 6 may be structured as shown in FIG. 11. When the S1AP: MME CONFIGURATION UPDATE message contains the information element (“Virtual GUMMEIs” IE) indicating the mapping between V-GUMMEIs and R-GUMMEIs, the eNodeB 112 overwrites this IE, that is, updates the transfer table 420 that is used to determine an MME to which a NAS message is to be forwarded.

When the eNodeB 112 performs MME selection by using the UE Identity (i.e., S-TMSI) contained in the RRC Connection Request message (e.g., in the case of Service Request), the eNodeB 112 may map the MMEC in the UE Identity (i.e., the MMEC of the V-GUMMEI) to the R-GUMMEI in accordance with the transfer table 420 in order to determine an MME to which the NAS message is to be forwarded. Likewise, when the eNodeB 112 performs MME selection by using the Registered MME information (“RegisteredMME” IE) contained in the RRC Connection Setup Complete message (e.g., in the case of TAU Request), the eNodeB 112 may map the MMEC in the Registered MME information (i.e., the MMEC of the V-GUMMEI) to the R-GUMMEI in accordance with the transfer table 420 in order to determine an MME to which the NAS message is to be forwarded. The eNodeB 112 may convert the MMEC of the V-GUMMEI in the UE Identity or Registered MME information into the corresponding MMEC of the R-GUMMEI and transmit the S1AP: INITIAL UE Message containing the MMEC of the R-GUMMEI.

Further, a new flag (e.g., “virtual”) indicating the V-GUMMEI is used may be defined in the “gummei-Type” IE contained in the RRC Connection Setup Complete message, and the eNodeB 112 may determine an MME to which the NAS message is forwarded based on this flag. Alternatively, an identification flag (e.g., “normal”, “virtual) indicating which the R-GUMMEI or the V-GUMMEI is used as the GUMMEI may be defined in the “gummei-Type” IE. For example, the MME (source MME 121S) may notify the UE 111 that the Registered MME information (i.e., GUMMEI) is linked to the V-GUMMEI. When the NAS layer sends the Registered MME information to the AS layer (RRC) to transmit an RRC Connection Setup Complete message, the NAS layer may also notify the AS layer that the Registered MME information is linked to the V-GUMMEI (or the information indicating which the R-GUMMEI or the V-GUMMEI is used as the GUMMEI). Moreover, the UE 111 may set the gummei-Type, which is one of the information elements contained in the RRC Connection Setup Complete message, to “virtual” and then transmit it to the eNodeB. The term (name) “virtual” that is set to the gummei-Type is merely an example. For example, when the terms “T-GUMMEI”, “L-GUMMEI”, or “second GUMMEI” are used instead of the term “V-GUMMEI”, the gummei-Type may be set to “temporal”, “logical”, or “secondary (-GUMMEI)”\.

In this illustrative embodiment, similar to the first illustrative embodiment, the transfer (relocation) of the mobility management and bearer management regarding the UE 111 in the idle state can be completed without involving signaling with the UE 111. Moreover, in this illustrative embodiment, one MME 121 can use multiple V-GUMMEIs, and the mobility management and bearer management regarding the UE 111 in the idle state can be transferred from the source MME 121S to the target MME 121T per V-GUMMEI. Accordingly, mobility management and bearer management can be transferred per V-GUMMEI even when normal GUMMEIs (i.e., R-GUMMEI s) that are unique to respective MMEs are used for signaling between the MMEs and the like. In other words, only the mobility management and bearer management regarding some of the UEs 111 managed by the source MME 121S, i.e., at least one UE 111 associated with a particular V-GUMMEI, can be transferred to the target MME 121T.

### Third Illustrative Embodiment

This illustrative embodiment provides some modifications to reduce the number of signaling messages generated in the procedure for transferring mobility management and bearer management. These modifications may be separately implemented or implemented in combination. A configuration example of a mobile communication network according to this illustrative embodiment may be the same as that shown in FIG. 1, which is described in the first illustrative embodiment.

In order to reduce the number of the signaling messages to be transmitted to the target MME 121T, the source MME 121S may transmit to the target MME 121T a signaling message containing UE contexts (MM contexts or EPS bearer contexts or both) for the plurality of UEs 111 for which the transfer of the mobility management and bearer management is performed. This provides a reduction of the number of occurrences of signaling compared to the case in which multiple signaling messages for respective UEs are transmitted. In order to further reduce the amount of data transmitted from the source MME 121S to the target 121T, the source MME 121S may compress the information element(s) in the UE contexts (e.g., GUMMEI (R-GUMMEI) or V-GUMMEI) that is common to the plurality of UEs 111, and thereby reduce the data size of the signaling message to be transmitted to the target MME 121T.

It is preferable to reduce the number of occurrences of signaling for changing, from the source MME 121S to the target MME 121T, the termination points of the multiple S11 GTP-C connections for the plurality of UEs 111. To this end, a part of the MME TEID (32-bit length) for S11 may be used as a region indicating a UE group identifier (ID) corresponding to the plurality of UEs 111 or a particular MMEC (8-bit length) contained in a particular GUMMEI associated with the plurality of UEs 111. FIG. 11 shows an example of a modified data structure of the MME TEID for S11. In the example of FIG. 11, the eight most significant bits of the S11 MME TEID 500 are used as a UE group ID 510. The UE group ID 510 is an identifier indicating the plurality of UEs 111 associated with the particular GUMMEI, for which the transfer of mobility management and bearer management is performed. The UE group ID 510 may be, for example, the MMEC contained in the particular GUMMEI. The remaining 24 bits of the MME TEID 500 shown in FIG. 11 are used as a region indicating the actual MME TEID that is unique in the MME.

Using a part of the MME TEID for S11 as the region for indicating the UE group ID (or the particular MMEC), it is possible to easily identify the S11 GTP-C connections that needs to be modified when mobility management and bearer management are transferred between MMEs. Accordingly, the target MME 121T only needs to notify the S-GW 123 of the UE group ID (or the particular MMEC), which is common to the plurality of UEs 111, in order to modify the multiple S11 GTP-C connections and does not need to notify the S-GW 123 of all of the identifiers of the UEs 111 (e.g., IMSIs or EPS bearer IDs). This provides a reduction of the number of the occurrences of signaling and the amount of transmission data necessary to modify the multiple S11 GTP-C connections.

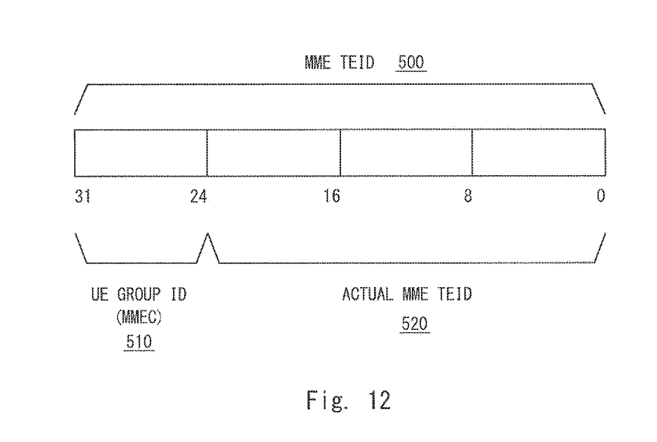

A specific example of the modification of the multiple S11 GTP-C connections will be described with reference to FIG. 12. The S-GW 123 uses one S11 GTP-C connection per UE. Accordingly, the S-GW 123 manages the identifier of the UE 111 (i.e., IMSI), the IP address of the MME, and the MME TEID for each S11 GTP-C connection. A table 530 shown in FIG. 12 manages five S11 GTP-C connections for five UEs 111 that are identified by IMSI #1 to IMSI #5. The S11 GTP-C connections for three UEs 111 identified by the IMSI #1 to IMSI #3 are associated with the IP address of the source MME 121S (IP address #1) and are thus connected to the source MME 121S. On the other hand, the S11 GTP-C connections for two UEs 111 identified by the IMSI #4 and IMSI #5 are associated with the IP address of the target MME 121T (IP address #2) and are thus connected to the target MME 121T.

Further, in the table 530, two UEs 111 identified by the IMSI #1 and IMSI #2 have the value “0xA1” in the eight most significant bits of their MME TEIDs. On the other hand, the UE 111 identified by the IMSI #3 has the value “0xA2” in the eight most significant bits of its MME TEID. The eight most significant bits of the MME TEID represent the UE group identifier (or the particular MMEC in the particular GUMMEI). Thus, it is easily recognized that the IMSI #1 and IMSI #2 belong to the same UE group identified by “0xA1”, while the IMSI #3 belongs to another UE group different from the UE group identified by “0xA1”.

In order to change, from the source MME 121S to the target MME 121T, the termination points of two S11 GTP-C connections for two UEs 111 (IMSI #1 and IMSI #2) that belong to the UE group identified by “0xA1”, the target MME 121T only needs to notify the S-GW 123 of the UE group identifier (or the particular MMEC) “0xA1”, and does not need to notify the S-GW 123 of the IMSI #1 and IMSI #2 for these two UEs 111. For example, the target MME 121T may transmit an MME Change Notification message 540 shown in FIG. 12. The MME Change Notification message 540 indicates the IP address of the source MME 121S (IP address #1) and the UE group identifier (or the particular MMEC) “0xA1” as the key information for a search, and indicates the IP address of the target MME 121T (IP address #2) as the modified value. In response to receiving the MME Change Notification message 540, the S-GW 123 may search the table 530 for the entry(ies) having the UE group identifier (or the particular MMEC) “0xA1” and overwrites the MME IP address (IP address #1) recorded in this entry(ies) with the IP address of the target MME 121T (IP address #2). A table 550 shown in FIG. 12 is the table that has been modified. A dotted frame 560 indicates the two modified IP addresses.

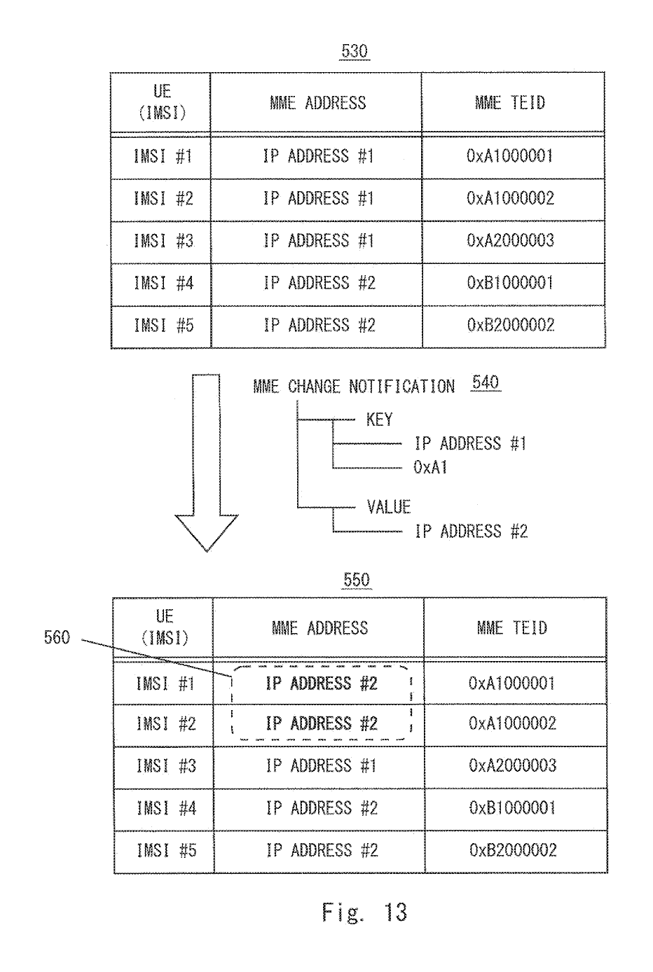

FIG. 13 shows a specific example of the procedure for transferring the mobility management and bearer management of the plurality of UEs 111 from the source MME 121A to the target MME 121T. In Step S501, the source MME 121S transmits to the target MME 121T a message containing the MM contexts and EPS bearer contexts for the plurality of UEs 111, for which the transfer will be performed (Relocation Request).

In Step S502, the target MME 121T receives the MM contexts and EPS bearer contexts for the plurality of UEs 111 from the source MME 121S, and stores them in its memory or storage (not shown). Further, the target MME 121T transmits to the S-GW 123 a message (MME Change Notification) to modify the S11 GTP-C connections for the plurality of UEs 111. The MME Change Notification indicates the identifier of the UE group (or the particular MMEC) to which the plurality of UEs 111 belong, instead of indicating the IMSIs of the plurality of UEs 111.

In Step S503, in response to receiving the MME Change Notification message (Step S502), the S-GW 123 modifies the multiple S11 GTP-C connections for the plurality of UEs 111 and transmits a response message (e.g., MME Change Response message) to the target MME 121T. Thus, the multiple S11 GTP-C connections 320 for the plurality of UEs 111 are established between the target MME 121T and the S-GW 123.

The processing of Steps S504 to S508 in FIG. 13 may be the same as the processing of Steps S104 to S108 in FIG. 4. Thus, the description related to Steps S504 to S508 will be omitted for this case.

The control node 142, instead of the target MME 121T, may instruct the S-GW 123 to perform the modification of the S11 GTP-C connections described in this illustrative embodiment.

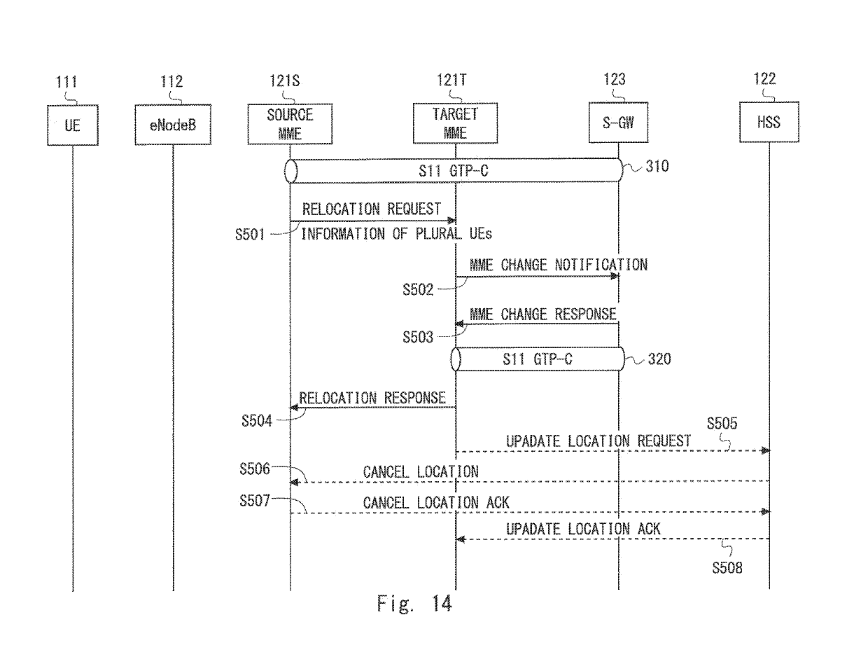

Lastly, configuration examples of the eNodeB 112, the source MME 121S, the target MME 121T, and the control node 142 according to the above-described first to third illustrative embodiments are described below. FIG. 14 shows a configuration example of the eNodeB 112. Referring to FIG. 14, the eNodeB 112 includes a wireless transceiver 1120, a network interface 1121, a processor 1122, and a memory 1123. The wireless transceiver 1120 is configured to communicate with the UE 111. The network interface 1121 is used to communicate with other eNodeBs in the E-UTRAN 110 and nodes (e.g., MME121S, MME121T, and S-GW 123) in the EPC 120.

The processor 1122 loads software (computer program) from the memory 1123 and executes the loaded software, thereby performing communication control including RRC and Radio Resource Management (RRM) and the operations of the eNodeB 112 described in the above illustrative embodiments. The processor 1122 may be, for example, a microprocessor, a Micro Processing Unit (MPU), or a Central Processing Unit (CPU). The processor 1122 may include a plurality of processors.

The memory 1123 is composed of a combination of a volatile memory and a nonvolatile memory. The volatile memory is, for example, a Static Random Access Memory (SRAM), a Dynamic RAM (DRAM), or a combination thereof. The nonvolatile memory is, for example, a mask Read Only Memory (MROM), a Programmable ROM (PROM), a flash memory, a hard disk drive, or a combination thereof. The memory 1123 may include a storage that is physically separated from the processor 1122. In this case, the processor 1122 may access the memory 1123 through the network interface 1121 or another I/O interface (not shown).

In the example of FIG. 14, the memory 1123 is used to store software modules including an RRC module 1124, an RRM module 1125, an X2 module 1126, an S1-MME module 1127, and an Operation and Maintenance (OAM) module 1128. The RRC module 1124 and the S1-MME module 1127 include instructions and data for performing transfer of the NAS message encapsulated in the received RRC message to the MME. Further, the OAM module 1128 includes instructions and data for communicating with the control node 1142. The processor 1122 loads the RRC module 1124, the S1-MME module 1127, and the OAM module 1128 from the memory 1123 and executes the loaded modules, thereby performing the operations of the eNodeB 112 regarding the transfer procedure of mobility management and bearer management described in the above illustrative embodiments.

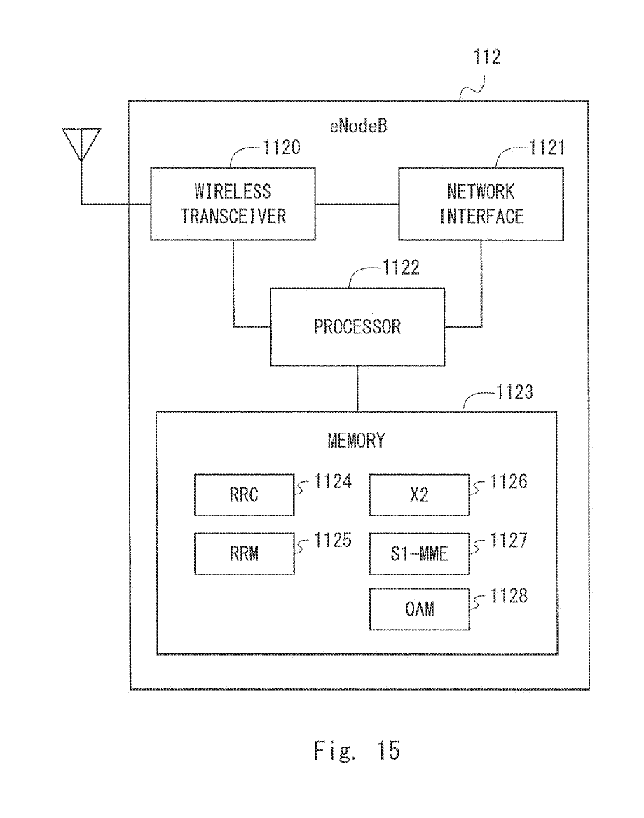

FIG. 15 shows a configuration example of the source MME 121S. The configuration of the target MME 121T may be the same as the configuration example shown in FIG. 15. Referring to FIG. 15, the MME 121S includes a network interface 1210, a processor 1211, and a memory 1212. The network interface 1210 is used to communicate with other network nodes (e.g., the eNodeB 112, the target MME 121T, the HSS 122, the S-GW 123). The network interface 1210 may include, for example, a network interface card (NIC) conforming to the IEEE 802.3 series.

The processor 1211 loads software (computer program) from the memory 1212 and executes the loaded software, thereby performing communication control (e.g., mobility management and bearer management). The processor 1211 may be, for example, a microprocessor, an MPU, or a CPU. The processor 1211 may include a plurality of processors.

The memory 1212 is composed of a combination of a volatile memory and a nonvolatile memory. The volatile memory is, for example, an SRAM, a DRAM, or a combination thereof. The nonvolatile memory is, for example, an MROM, a PROM, a flash memory, a hard disk drive, or a combination thereof. The memory 1212 may include a storage that is physically separated from the processor 1211. In this case, the processor 1211 may access the memory 1212 through the network interface 1210 or another I/O interface (not shown).

In the example of FIG. 15, the memory 1212 is used to store software modules including an S1-MME module 1213, an S6a module 1214, an S10 module 121S, an S11 module 1216, a NAS module 1217, an EPS Mobility Management (EMM) and EPS Session Management (ESM) module 1218, and an OAM module 1219. The OAM module 1219 includes instructions and data for controlling the communication with the control node 142 and the relocation, which are described in the above illustrative embodiments. The processor 1211 loads the OAM module 1219, S1-MME module 1213, S11 module 1216 and the like from the memory 1212 and executes the loaded module, thereby performing the operations of the source MME 121S regarding the relocation procedure of mobility management and bearer management described in the above illustrative embodiments.

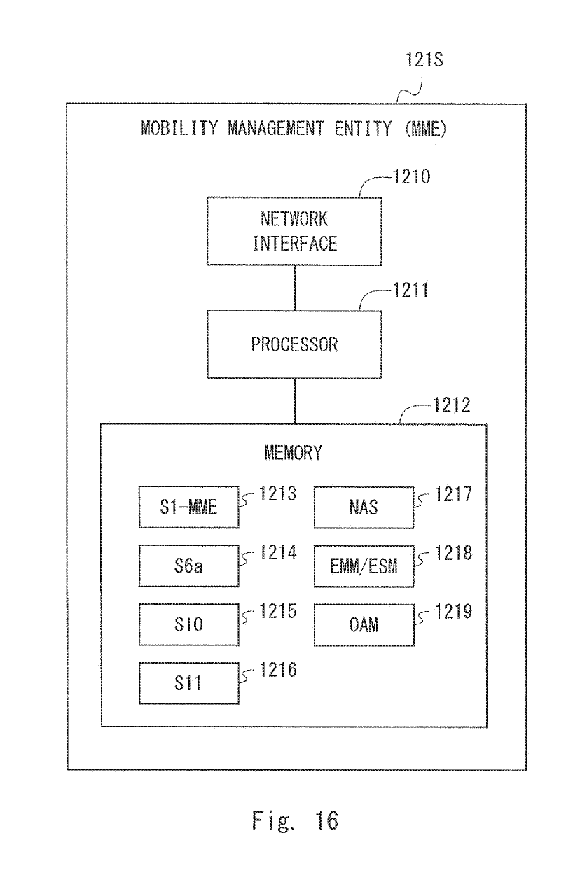

FIG. 16 shows a configuration example of the control node 142. Referring to FIG. 16, the control node 142 includes a network interface 1420, a processor 1421, and a memory 1422. The network interface 1420 is used to communicate with network nodes (e.g., the eNodeB 112, the target MME 121T, the HSS 122, the S-GW 123). The network interface 1420 may include, for example, a network interface card (NIC) conforming to the IEEE 802.3 series.

The processor 1421 loads software (computer program) from the memory 1422 and executes the loaded software, thereby performing control related to transfer of mobility management and bearer management between MMEs. The processor 1421 may be, for example, a microprocessor, a MPU, or a CPU. The processor 1421 may include a plurality of processors.

The memory 1422 is composed of a combination of a volatile memory and a nonvolatile memory. The volatile memory is, for example, an SRAM, a DRAM, or a combination thereof. The nonvolatile memory is, for example, an MROM, a PROM, a flash memory, a hard disk drive, or a combination thereof. The memory 1422 may include a storage that is physically separated from the processor 1421. In this case, the processor 1421 may access the memory 1422 through the network interface 1420 or another I/O interface (not shown).

In the example of FIG. 16, the memory 1422 is used to store software modules including a relocation management module 1423. The relocation management module 1423 includes instructions and data for performing control related to transfer of mobility management and bearer management between MMEs, which has been described in the above illustrative embodiments. The processor 1421 loads the OAM module 1219 and the relocation management module 1423 from the memory 1422 and executes the loaded modules, thereby performing the operations of the control node 142 regarding the relocation procedure of mobility management and bearer management described in the above illustrative embodiments.

As described with reference to FIGS. 14 to 16, each of processors included in the source MME 121S, the target MME 121T, and the control node 142 according to the above-described illustrative embodiments executes one or more programs including a set of instructions that causes a computer to perform algorithms described using the sequence charts and the like.

These programs can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). These programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

### OTHER ILLUSTRATIVE EMBODIMENTS

The procedures for transferring mobility management and bearer management described in the above illustrative embodiments may be modified as appropriate. For example, FIG. 3 shows an example where the source MME 121S receives the Relocation Command message from the control node 142. However, the target MME 121T, instead of the source MME 121S, may receive the Relocation Command message from the control node 142 and initiate the relocation procedure.

The above-described illustrative embodiments are described mainly using specific examples related to the EPS. However, these illustrative embodiments may be applied to other mobile communication systems, such as Universal Mobile Telecommunications System (UMTS), 3GPP2 CDMA2000 system (1×RTT, High Rate Packet Data (HRPD)), Global System for Mobile communications (GSM (registered trademark))/General packet radio service(GPRS) system, and mobile WiMAX system, for example.

Further, the above-described illustrative embodiments are merely examples of applications of the technical ideas obtained by the inventors. Therefore, the technical ideas are not limited to the above-described illustrative embodiments, and various changes and modifications may be made as a matter of course.

This application is based upon and claims the benefit of priority from Japanese Patent Application No. 2014-181169, filed on Sep. 5, 2014, the disclosure of which is incorporated herein in its entirety by reference.

### REFERENCE SIGNS LIST

110 EVOLVED UNIVERSAL TERRESTRIAL RADIO ACCESS NETWORK (E-UTRAN)
111 USER EQUIPMENT (UE)
112 eNodeB
121S SOURCE MOBILITY MANAGEMENT ENTITY (MME)
121T TARGET MME
122 HOME SUBSCRIBER SERVER (HSS)
123 SERVING GATEWAY (S-GW)
124 PACKET DATA NETWORK GATEWAY (P-GW)
120 EVOLVED PACKET CORE (EPC)
130 PACKET DATA NETWORK (PDN)
141 CONTROL INTERFACE
142 CONTROL NODE
1122, 1211, 1421 PROCESSOR
1123, 1212, 1422 MEMORY

1-13. (canceled)

14. A method performed by a base station comprising:
when mobility management and bearer management of at least one mobile terminal, in an idle state and associated with a particular core network node identifier, are transferred from a first core network node to a second core network node, configuring the base station to change a forwarding destination of a Non-Access Stratum (NAS) message from the first core network node to the second core network node, the NAS message being transmitted by each of the at least one mobile terminal and being addressed to the particular core network node identifier.

15. The method according to claim 14, wherein
said configuring comprises changing, in a transfer table held by the base station, a core network node associated with the particular core network node identifier from the first core network node to the second core network node, and
the transfer table is used by the base station in order to determine a core network node to which the NAS message is to be forwarded.

16. The method according to claim 15, wherein the transfer table associates the particular core network node identifier with an address of the first or second core network node used for data packet transfer.

17. The method according to claim 15, wherein
each of the first and second core network nodes is configured with a unique core network node identifier to be differentiated from other core network nodes and is configured to perform mobility management and bearer management using a multiple virtual core network node identifiers,
the particular core network node identifier is one of the multiple virtual core network identifiers, and
the transfer table associates the particular core network node identifier with the unique core network node identifier of the first or second core network node.

18-49. (canceled)

50. A base station comprising:
at least one memory that stores the instructions; and
at least one processor configured to execute the instructions to, when mobility management and bearer management of at least one mobile terminal, in an idle state and associated with a particular core network node identifier, are transferred from a first core network node to a second core network node, configure the base station to change a forwarding destination of a Non-Access Stratum (NAS) message from the first core network node to the second core network node, the NAS message being transmitted by each of the at least one mobile terminal and being addressed to the particular core network node identifier.

51. The base station according to claim 50, wherein
the instructions causes the at least one processor to change, in a transfer table held by the base station, a core network node associated with the particular core network node identifier from the first core network node to the second core network node, and
the transfer table is used by the base station in order to determine a core network node to which the NAS message is to be forwarded.

52. The base station according to claim 51, wherein the transfer table associates the particular core network node identifier with an address of the first or second core network node used for data packet transfer.

53. The base station according to claim 51, wherein
each of the first and second core network nodes is configured with a unique core network node identifier to be differentiated from other core network nodes and is configured to perform mobility management and bearer management using a multiple virtual core network node identifiers,
the particular core network node identifier is one of the multiple virtual core network identifiers, and
the transfer table associates the particular core network node identifier with the unique core network node identifier of the first or second core network node.

54. The base station according to claim 50, wherein the instructions causes the at least one processor to receive, from a control node coupled to a core network including the first and second core network nodes, a command indicating a change of the forwarding destination of the NAS message.

55. The base station according to claim 50, wherein the instructions causes the at least one processor to receive, from the first or second core network node, a command indicating a change of the forwarding destination of the NAS message.

56. A first core network node located in a core network, the first core network node comprising:
at least one memory that stores the instructions; and
at least one processor configured to execute the instructions to: transfer mobility management and bearer management of at least one mobile terminal from the first core network node to a second core network node, the at least one mobile terminal being in an idle state and being associated with a particular core network node identifier; and
instruct a base station to change a forwarding destination of a Non-Access Stratum (NAS) message from the first core network node to the second core network node upon the transfer of the mobility management and the bearer management of the at least one mobile terminal, the NAS message being transmitted by each of the at least one mobile terminal and being addressed to the particular core network node identifier.

57. The first core network node according to claim 56, wherein the transfer of the mobility management and the bearer management is initiated regardless of movement of the at least one mobile terminal, and is initiated autonomously by the first or second core network node or initiated in response to a command from a control node coupled to a core network.

58. The first core network node according to claim 56, wherein the transfer of the mobility management and the bearer management and the instruction to the base station cause the second core network node and the at least one mobile terminal to continuously use the particular core network node identifier without notifying the at least one mobile terminal of an update of the particular core network node identifier.

59. The first core network node according to claim 56, wherein
each of the first and second core network nodes is configured with a unique core network node identifier to be differentiated from other core network nodes and is configured to perform mobility management and bearer management using a multiple virtual core network node identifiers, and
the particular core network node identifier is one of the multiple virtual core network identifiers.

60. The first core network node according to claim 56, wherein
the instructions causes the at least one processor to instruct the base station to change, in a transfer table held by the base station, a core network node associated with the particular core network node identifier from the first core network node to the second core network node, and
the transfer table is used by the base station in order to determine a core network node to which the NAS message is to be forwarded.

61. The first core network node according to claim 60, wherein the transfer table associates the particular core network node identifier with an address of the first or second core network node used for data packet transfer.

62. The first core network node according to claim 60, wherein
each of the first and second core network nodes is configured with a unique core network node identifier to be differentiated from other core network nodes and is configured to perform mobility management and bearer management using a multiple virtual core network node identifiers,
the particular core network node identifier is one of the multiple virtual core network identifiers, and
the transfer table associates the particular core network node identifier with the unique core network node identifier of the first or second core network node.

63. The first core network node according to claim 56, wherein the instructions further causes the at least one processor to notify each of the at least one mobile terminal of the particular core network node identifier during an attach procedure or a location update procedure of each of the at least one mobile terminal and prior to said transferring.

64. The first core network node according to claim 56, wherein the instructions causes the at least one processor to perform a procedure for transferring the mobility management and the bearer management, wherein
the procedure comprises:
transmitting a mobility context for the at least one mobile terminal from the first core network node to the second core network node; and
transmitting a bearer management context for the at least one mobile terminal from the first core network node to the second core network node.

65. The first core network node according to claim 64, wherein
the at least one mobile terminal comprises a plurality of mobile terminals, and
the instructions causes the at least one processor to transmit a signaling message containing the mobility context for the plurality of mobile terminals.
